(19) United States
(12) Patent Application Publication
(10) Pub. No.: US 2018/0240213 A1
(43) Pub. Date: Aug. 23, 2018

(54) INFORMATION PROCESSING SYSTEM, INFORMATION PROCESSING METHOD, AND PROGRAM

(71) Applicant: SONY CORPORATION, Tokyo (JP)

(72) Inventors: Akihiko IZUMI, Kanagawa (JP); Takuya NAMAE, Kanagawa (JP); Kenji HISANAGA, Tokyo (JP)

(73) Assignee: SONY CORPORATION, Tokyo (JP)

(21) Appl. No.: 15/887,194

(22) Filed: Feb. 2, 2018

(30) Foreign Application Priority Data
Feb. 17, 2017 (JP) 2017-027642

(51) Int. Cl. G06T 3/00; G06F 3/042; G06F 3/0481

(52) U.S. Cl. CPC G06T 3/0006; G06F 3/04883; G06F 3/0481; G06F 3/0425

(57) ABSTRACT

There is provided an information processing system including: an acquisition unit configured to acquire direction information indicating a rotational angle of a display object displayed on a display screen, the rotational angle being with respect to a reference angle on the display screen, or a direction in which a user is positioned with respect to the display screen; and a decision unit configured to decide, on a basis of the direction information, a direction of the display object with respect to the display screen when a display mode of the display object is switched to an enlarged display mode, in which the rotational angle of the display object is different from a rotational angle of the display screen.

### CROSS REFERENCE TO RELATED APPLICATIONS

This application claims the benefit of Japanese Priority Patent Application JP 2017-027642 filed Feb. 17, 2017, the entire contents of which are incorporated herein by reference.

### BACKGROUND

The present disclosure relates to an information processing system, an information processing method, and a program.

In the past, touch panels capable of detecting the contact or proximity of a user's finger with respect to a display screen have been developed.

For example, JP 2004-272835A describes a technology in which, when a user performs a gesture of drawing a rectangle or circle with a finger, pen, or the like, the size of a window is prescribed according to the size of the gesture.

### SUMMARY

However, in the technology described in Patent Literature 1, no consideration is given for displaying a window by switching the display mode of the window to an enlarged display mode by an appropriate method.

Accordingly, the present disclosure proposes a new and improved information processing system, information processing method, and program capable of appropriately deciding the direction of a display object when the display mode of the display object is switched to an enlarged display mode.

According to the present disclosure, there is provided an information processing system including: an acquisition unit configured to acquire direction information indicating a rotational angle of a display object displayed on a display screen, the rotational angle being with respect to a reference angle on the display screen, or a direction in which a user is positioned with respect to the display screen; and a decision unit configured to decide, on a basis of the direction information, a direction of the display object with respect to the display screen when a display mode of the display object is switched to an enlarged display mode, in which the rotational angle of the display object is different from a rotational angle of the display screen.

Also, according to the present disclosure, there is provided an information processing method including: acquiring direction information indicating a rotational angle of a display object displayed on a display screen, the rotational angle being with respect to a reference angle on the display screen, or a direction in which a user is positioned with respect to the display screen; and deciding, by a processor, on a basis of the direction information, a direction of the display object with respect to the display screen when a display mode of the display object is switched to an enlarged display mode, in which the rotational angle of the display object is different from a rotational angle of the display screen.

Also, according to the present disclosure, there is provided a program causing a computer to function as: an acquisition unit configured to acquire direction information indicating a rotational angle of a display object displayed on a display screen, the rotational angle being with respect to a reference angle on the display screen, or a direction in which a user is positioned with respect to the display screen; and a decision unit configured to decide, on a basis of the direction information, a direction of the display object with respect to the display screen when a display mode of the display object is switched to an enlarged display mode, in which the rotational angle of the display object is different from a rotational angle of the display screen.

According to the present disclosure as described above, the direction of a display object can be decided appropriately when the display mode of the display object is switched to an enlarged display mode. Note that the advantageous effect described herein is not necessarily limited, and may also be any of the advantageous effects described in this disclosure.

### BRIEF DESCRIPTION OF THE DRAWINGS

FIG. 1 is an explanatory diagram illustrating an exemplary configuration of an information processing system 10 according to an embodiment of the present disclosure;

FIG. 2A is an explanatory diagram illustrating an example of a window system in which windows are operated from a front direction of a screen 20;

FIG. 2B is an explanatory diagram illustrating an example of a window system in which individual windows are operated from arbitrary directions;

FIG. 3 is an explanatory diagram illustrating another exemplary configuration of the information processing system 10 according to the embodiment;

FIG. 4 is an explanatory diagram illustrating another exemplary configuration of the information processing system 10 according to the embodiment;

FIG. 5A is a diagram illustrating an example in which a window 30 is displayed in a rotated state with respect to the screen 20;

FIG. 5B is a diagram illustrating a display example when, in the situation illustrated in FIG. 5A, a window is displayed in full screen by publicly known technology;

FIG. 6 is a function block diagram illustrating an exemplary functional configuration of the information processing system 10 according to the embodiment;

FIG. 7 is an explanatory diagram illustrating a decision example of deciding the direction and size of the window 30 when the display mode switched to a full screen display mode;

FIG. 8 is an explanatory diagram illustrating a decision example of deciding the direction and size of the window 30 when the display mode switched to a full screen display mode;

FIG. 9 is an explanatory diagram illustrating a decision example of deciding the direction and size of the window 30 when the display mode switched to a full screen display mode;

FIG. 10 is an explanatory diagram illustrating a decision example of deciding the direction and size of the window 30 when the display mode switched to a full screen display mode;

FIG. 11 is an explanatory diagram illustrating a decision example of deciding the direction and size of the window 30 when the display mode switched to a full screen display mode;

FIG. 12 is an explanatory diagram illustrating a decision example of deciding the direction and size of the window 30 when the display mode switched to a full screen display mode;

FIG. 13 is an explanatory diagram illustrating a decision example of deciding the direction and size of the window 30 when the display mode switched to a full screen display mode;

FIG. 14 is an explanatory diagram illustrating an example of deciding the direction and size of the window 30 when the display mode is switched to a full screen display mode in accordance with the position of a user;

FIG. 15 is an explanatory diagram illustrating an example of deciding the direction and size of the window 30 when the display mode is switched to a full screen display mode in accordance with the position of a user;

FIG. 16A is an explanatory diagram illustrating a decision example of deciding the size of the window 30 when the display mode is switched to a full screen display mode in a scene in which an object 40 is placed on the screen 20;

FIG. 16B is an explanatory diagram illustrating a decision example of deciding the size of the window 30 when the display mode is switched to a full screen display mode in a scene in which an object 40 is placed on the screen 20;

FIG. 17A is an explanatory diagram illustrating an example in which the entire window 30 is displayed in full screen;

FIG. 17B is an explanatory diagram illustrating an example in which one user interface (UI) object 32 inside the window 30 is displayed in full screen;

FIG. 18A is an explanatory diagram illustrating an example in which the window 30 is switched to a full window display mode;

FIG. 18B is an explanatory diagram illustrating an example in which the window 30 is switched to a full window display mode;

FIG. 19 is a sequence diagram illustrating a “flow of processes when switching from a normal display to an enlarged display” according to the embodiment;

FIG. 20 is a flowchart illustrating a flow of a “process of deciding the display direction/size during full screen display” according to the embodiment;

FIG. 21 is a sequence diagram illustrating a “flow of processes when switching from a full screen display to a normal display” according to the embodiment;

FIG. 22 is a flowchart illustrating a flow of a “process of canceling full screen display” according to the embodiment;

FIG. 23 is an explanatory diagram illustrating a hardware configuration of the information processing system 10 according to the embodiment;

FIG. 24 is an explanatory diagram illustrating an example of displaying the window 30 on an omnidirectional screen 50 according to a modification of the embodiment; and

FIG. 25 is an explanatory diagram illustrating an example of displaying the window 30 in full screen simultaneously on terminals 52 placed in multiple locations, according to a modification of the embodiment.

### DETAILED DESCRIPTION OF THE EMBODIMENT(S)

Hereinafter, (a) preferred embodiment(s) of the present disclosure will be described in detail with reference to the appended drawings. Note that, in this specification and the appended drawings, structural elements that have substantially the same function and structure are denoted with the same reference numerals, and repeated explanation of these structural elements is omitted.

Also, in this specification and the appended drawings, multiple component elements having substantially the same functional configuration may in some cases be distinguished by different letters appended to the same sign. For example, multiple components having substantially the same functional configuration are distinguished like the window 30a and the window 30b as appropriate. On the other hand, when it is not necessary to particularly distinguish each of multiple component elements having substantially the same functional configuration, only the same sign will be given. For example, the window 30a and the window 30b will be simply designated the window 30 when not being particularly distinguished.

In addition, the detailed description of the embodiments in this section will be given in the order indicated below.

1. Configuration of information processing system

2. Detailed description of embodiment

3. Hardware configuration

4. Modifications

### 1. Configuration of Information Processing System

First, an exemplary configuration of the information processing system 10 according to an embodiment of the present disclosure will be described. FIG, 1 is an explanatory diagram illustrating an exemplary configuration of the information processing system 10 according to an embodiment of the present disclosure. Note that in this specification, a system may mean a configuration for executing predetermined processes. A system may include a single device, or may include multiple devices. Also, it is sufficient for the information processing system 10 according to the present embodiment to be configured to be capable of executing predetermined processes as the information processing system 10 as a whole, and which components inside the information processing system 10 are to be treated as a single device may be arbitrary.

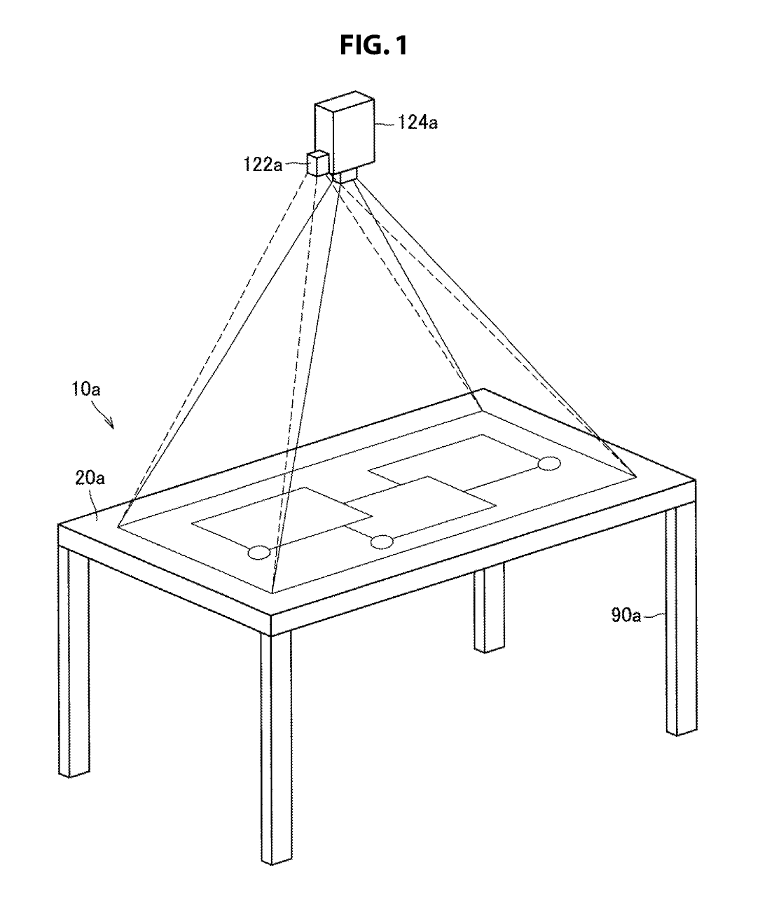

Referring to FIG. 1, the information processing system 10a according to an embodiment of the present disclosure is provided with a sensor unit 122a and a display unit 124a.

### 1-1. Display Unit 124

The display unit 124a displays various types of information on top of a table 90a. The display unit 124a may be a projection unit (projector). For example, as illustrated in FIG. 1, the display unit 124a may be placed above the table 90b and separated a predetermined distance from the table 90a, in a state of hanging down from the ceiling. In this case, the display unit 124a projects information onto the top face of the table 90a. The method of displaying information on the top face of the table 90a from above in this way is also called the “projection type”. Also, in the following, the top face of the table 90 is designated the screen 20 in some cases. In addition, the screen 20 is one example of a projection target in the present disclosure. The screen 20 includes a face (display face) that acts as the target of projection by the display unit 124.

Although details will be described later, the information processing system 10a may include multiple applications 200. In this case, the display unit 124a, under control by each of the multiple applications 200, is able to display display objects corresponding to each of the applications 200. Herein, display objects are windows or UI objects, for example. A UI object is one example of an operation object in the present disclosure. A UI object is, for example, a predetermined image (still image or moving image) that accepts various operations (such as selection and input) by a user. For example, a UI object is an image that includes a graphical user interface (GUI) part (such as a button, slider, checkbox, text box, or software keyboard, for example). Also, UI objects may be arranged inside a window.

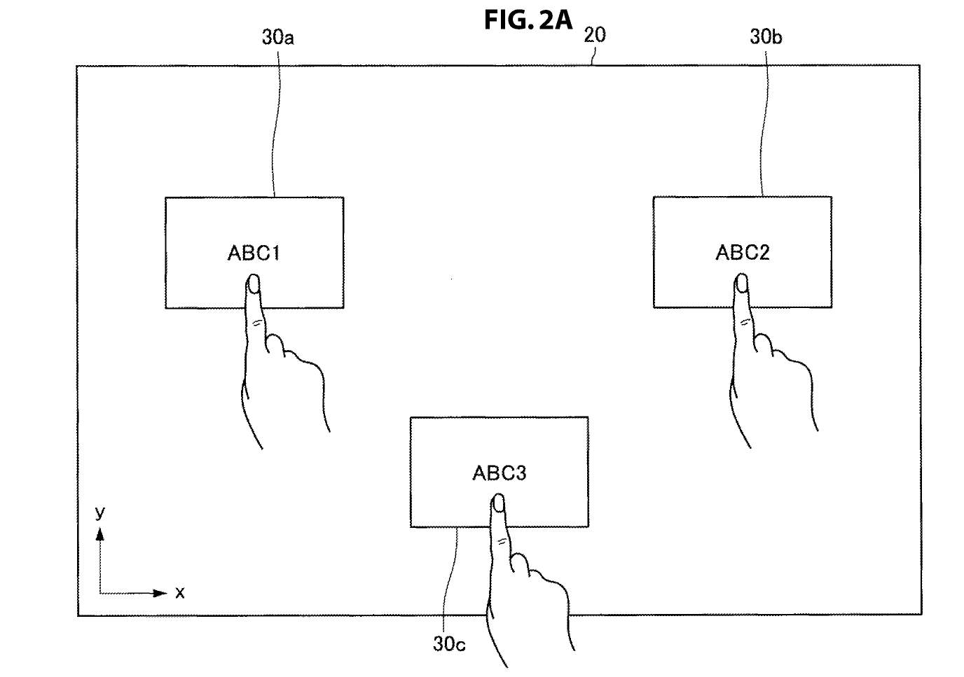

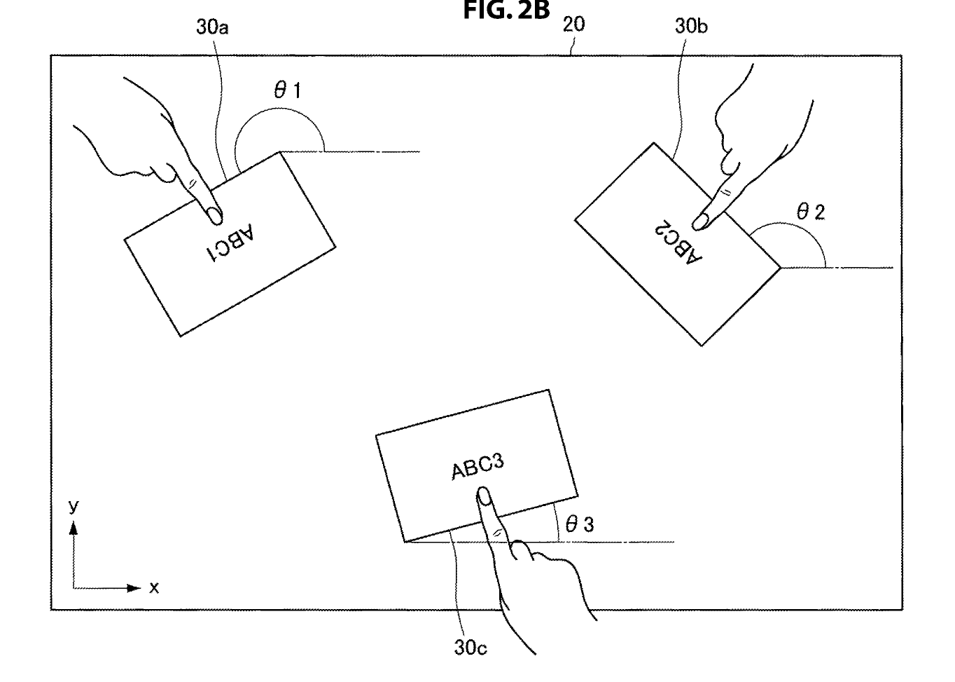

Meanwhile, publicly known window systems are designed under the presupposition of basically being operated from the front direction of the screen, as illustrated in FIG. 2A, for example. For this reason, operations from other than the front direction may be difficult for a user to perform.

On the other hand, in the information processing system 10a according to the present embodiment, display objects (for example, windows 30) corresponding to individual applications 200 can be displayed on the display unit 124 at arbitrary rotational angles with respect to a reference angle for the screen 20, as illustrated in FIG. 2B, for example. For example, at least two display objects (for example, windows 30) may be projected onto the screen 20 by the display unit 124, and in addition, may be projected so that the respective rotational angles of the at least two display objects with respect to the screen 20 are different from each other. With this arrangement, for example, in a use case in which multiple users surround the screen 20 and perform unorganized operations (for example, perform operations in an uncoordinated manner), each window 30 can be displayed at a convenient rotational angle for each of the multiple users. Additionally, each user can perform operations on the windows 30 in a highly convenient manner. Also, interactive operations can be realized among the users surrounding the screen 20, such as causing a display object to move towards a peer, for example.

### 1-2. Sensor Unit 122

The sensor unit 122a includes, for example, a camera that images the table 90a with a single lens, or a stereo camera capable of imaging the table 90a with two lenses and recording information in the depth direction. For the stereo camera, a visible light camera, an infrared camera, or the like may be used, for example. Also, the sensor unit 122a additionally may include a sound input device such as a microphone that picks up speech uttered by users, or environmental sounds from the surrounding environment.

In the case in which the camera images the table 90a with a single lens as the sensor unit 122a, the information processing system 10a is able to analyze an image taken by the camera (taken image), and thereby detect the position of an object (such as a users hand, for example) positioned on the screen 20. Also, in the case in which a stereo camera is used as the sensor unit 122a, the information processing system 10a is able to analyze a taken image taken by the stereo camera, and thereby acquire position information regarding an object positioned on the screen 20, as well as depth information regarding the object. On the basis of the depth information, the information processing system 10a becomes able to detect the contact or proximity of a user's hand on the screen 20 in the height direction, and the removal of the hand from the screen 20. Note that in the following description, the user causing an operating body (such as the users hand, for example) to contact or come into proximity of the screen 20 will also be collectively referred to simply as “contact”. Note that the sensor unit 122a may also include a depth sensor instead of the stereo camera. In this case, the depth sensor is capable of acquiring depth information regarding an object positioned on the screen 20.

In the present embodiment, on the basis of a taken image taken by the sensor unit 122a, the position of an operating body on the screen 20 is detected, and in addition, various types of information is input on the basis of the detected position of the operating body. In other words, the user is able to perform various types of operation input by moving the operating body over the screen 20. For example, by detecting the contact of the user's hand with respect to the window 30 or a UI object, operation input with respect to the window 30 or the UI object is performed. Note that in the following description, an example in which the operating body is a user's hand is described as an example, but the operating body is not limited to such an example, and may be any of various types of operating members, such as a stylus.

Additionally, the camera included in the sensor unit 122a may not only photograph the top face of the table 90a, but also photograph users present around the table 90a. In this case, the information processing system 10a is able to detect the positions of users around the table 90a on the basis of a taken image taken by the sensor unit 122a. Also, on the basis of a taken image, the information processing system 10a may extract physical features (such as face and body size) by which individual users may be specified, and thereby perform personal recognition of users.

Note that operation input of a user may also be executed by another method, without being limited to the example described above. For example, the sensor unit 122a may also be installed as a touch panel on the top face (screen 20a) of the table 90a, and in addition, operation input of a user may be detected by the contact of the user's finger or the like with respect to the touch panel. Additionally, operation input of a user may also be detected by a gesture with respect to a camera included in the sensor unit 122a.

### 1-3. Modifications

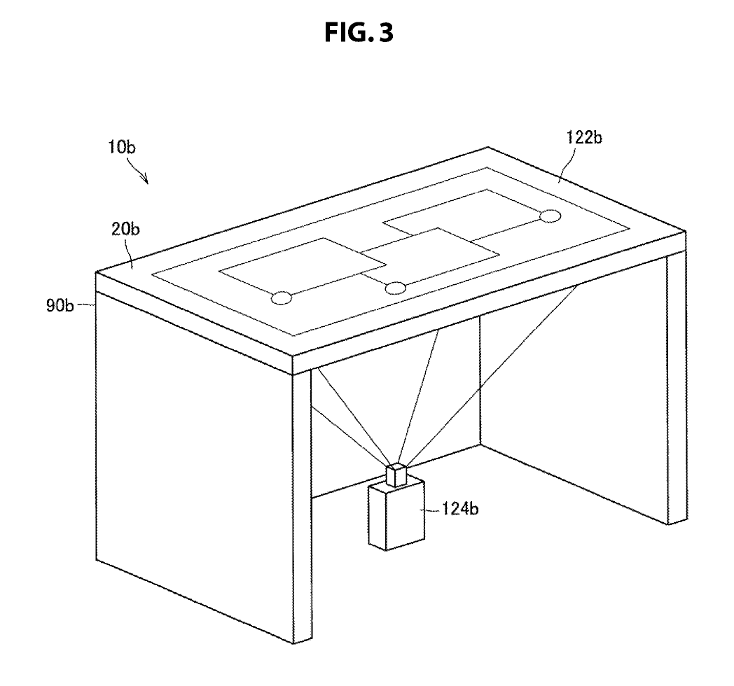

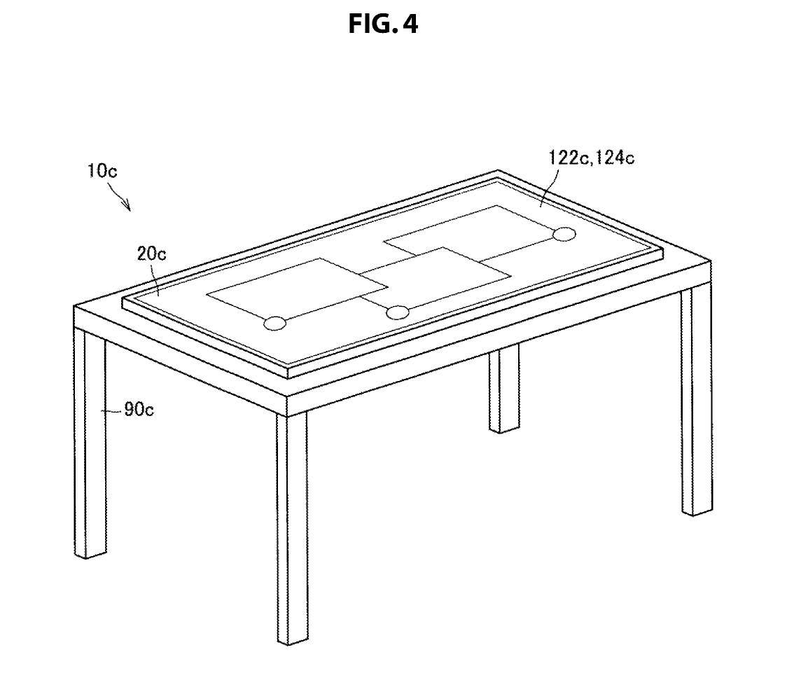

The above describes a configuration of the information processing system 10a according to the present embodiment. Note that the configuration of the information processing system according to the present embodiment is not limited. to the example illustrated in FIG. 1, and may also be a configuration as illustrated in FIG. 3 or FIG. 4, for example.

### 1-3-1. Modification 1

FIG. 3 is a diagram illustrating another exemplary configuration (information processing system 10b) of the information processing system according to the present embodiment. As illustrated in FIG. 3, in the information processing system lob, the display unit 124b is installed below the table 90b. The display unit 124b is a projector, for example, and projects information from underneath towards the tabletop of the table 90b. For example, the tabletop of the table 90b is formed from a transparent material, such as a glass pane or a transparent plastic panel, for example. Additionally, the information projected by the display unit 124b is displayed on the top face (screen 20b) of the table 90b (transmitted through the tabletop). The method of displaying information on the screen 20b by causing the display unit 124b to project information from under the table 90b in this way is also called the “rear projection type”.

Also, in the example illustrated in FIG. 3, the sensor unit 122b is provided on the screen 20b (surface). The sensor unit 122b includes a touch panel, for example. In this case, by having the touch panel detect the contact of an operating body on the screen 20b, operation input by a user is performed. Note that the configuration is not limited to such an example, and similarly to the information processing system 10a illustrated in FIG. 1, the sensor unit 122b may also be installed separated from the table 90b under the table 90b. In this case, the sensor unit 122b includes a camera, and in addition, the camera may photograph an operating body positioned on the screen 20b through the tabletop of the table 90b. Subsequently, on the basis of the photographed image, the position of the operating body may be detected.

### 1-3-2. Modification 2

FIG. 4 is a diagram illustrating yet another exemplary configuration (information processing system 10c) of the information processing system according to the present embodiment. As illustrated in FIG. 4, in the information processing system 10c, a touch panel display is installed on top of the table 90c, in a state in which the display face is directed upward. In the information processing system 10c, the sensor unit 122c and the display unit 124c may be configured in an integrated manner as the touch panel display. In other words, various types of information is displayed on the display screen (screen 20c) of the display, and in addition, by having the touch panel detect the contact of an operating body with respect to the display screen of the display, operation input by a user is performed. Note that even in the information processing system 10c, similarly to the information processing system 10a illustrated in FIG. 1, the sensor unit 122c may include a camera, and in addition, the camera may be installed above the display unit 124c. In this case, on the basis of a photographed image photographed by the camera, the positions and the like of individual users positioned around the table 90c may be detected.

### 1-4. Summary of Issues

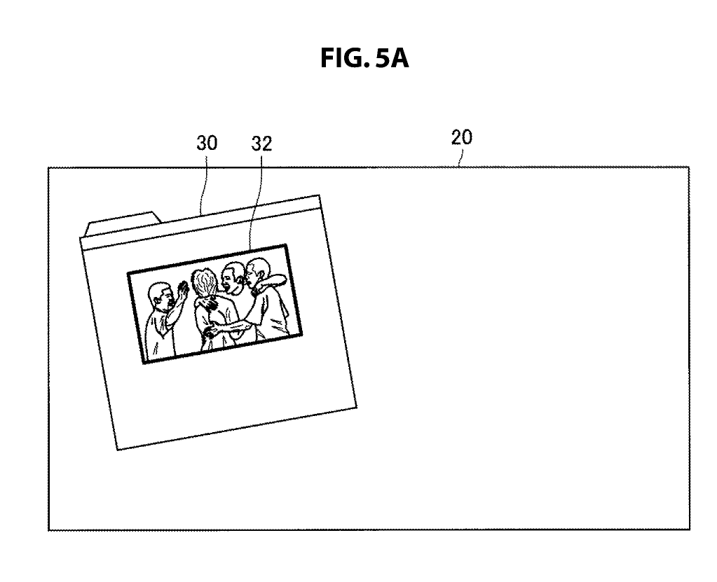

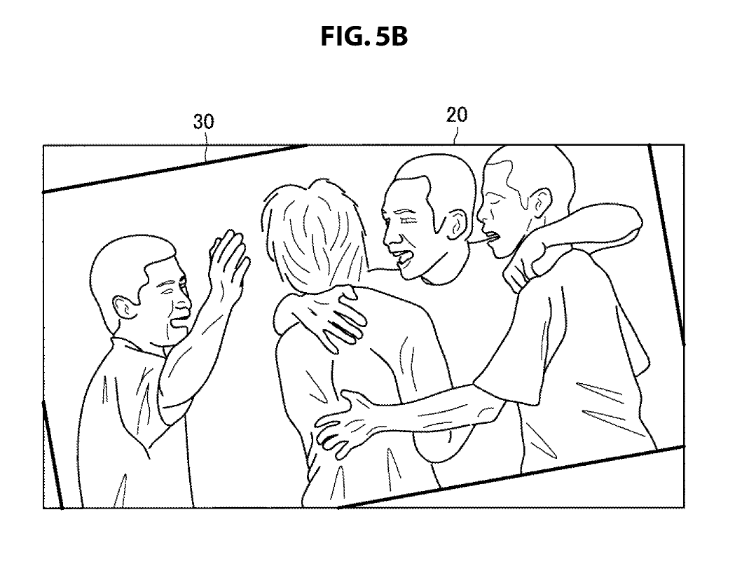

The above describes another exemplary configuration of the information processing system according to the present embodiment. By the way, it is also desired for the window 30 projected onto the screen 20 to be displayed in full screen on the screen 20. However, with the publicly known technology, the window 30 is displayed in full screen without changing the current direction of the window 30 with respect to the screen 20. For this reason, if the window 30 is displayed in full screen while still being rotated with respect to the screen 20, as illustrated in FIG. 5A, for example, places may be produced where part of the window 30 sticks out beyond the screen 20, or where the window 30 does not fully cover the screen 20 even when displayed in full screen, as illustrated in FIG. 5B. In other words, with the publicly known technology, the display quality When the window 30 is displayed in full screen may be lowered.

Accordingly, focusing on the above circumstances led to the creation of the information processing system 10 according to the present embodiment. The information processing system 10 is capable of acquiring direction information indicating a rotational angle of a display object displayed on a display screen, the rotational angle being with respect to a reference angle on the display screen, or a direction in which a user is positioned with respect to the display screen, and in addition, is capable of deciding, on the basis of the direction information, the direction of the display object with respect to the display screen when a. display mode of the display object is switched to an enlarged display mode. With this arrangement, the direction of the display object can be decided appropriately when the display mode of the display object is switched to the enlarged display mode.

Herein, the reference angle for the display screen is an internal (logical or relative) reference angle of software included in the information processing system 10, and may be an angle with respect to an “x-axis” as a reference (for example, 0 degrees with respect to the x-axis). Also, the rotational angle of the display object may be the angle from the x-axis of the display object with respect to the reference angle for the display screen (in other words, the reference angle in software). In other words, each of the “reference angle for the display screen” and the “rotational angle of the display object” is invariable, even if the display unit 124a (such as a projector) illustrated in FIG. 1 or the display unit 124c (touch display) illustrated in FIG. 4 rotates, for example.

Also, in the present embodiment, a rotational angle of the display screen may mean an angle in physical space of the entire projection region projected or displayed on the screen 20. For example, the rotational angle of the display screen is the rotational angle of the display unit 124a (such as a projector), the physical rotational angle of the display unit 124c (touch display) illustrated in FIG. 4, or the like. In other words, the rotational angle of the display screen may be different from the rotational angle of the display object. For example, in the present embodiment, the rotational angle of the display object changes due to user adjustments and the like, without being dependent on the rotational angle of the display screen.

Also, the display mode includes a normal display mode and an enlarged display mode. The normal display mode may be a mode in which multiple display objects are displayed typically. Also, in the normal display mode, the display objects may be displayed at least smaller than during the enlarged display mode. Note that in the normal display mode, only a single display object may also be displayed.

Also, the enlarged display mode may be a mode in which the display object is displayed on the display screen larger than in the normal display mode. For example, the enlarged display mode includes a full screen mode. Alternatively, in the enlarged display mode, the display object displayed enlarged may also be displayed on the display screen at a size smaller than full screen. Also, in this case, other display objects may also be displayed in the leftover portions (that is, the portions where the display object is not being displayed).

### 2. Detailed Description of Embodiment

### 2-1. Functional Configuration

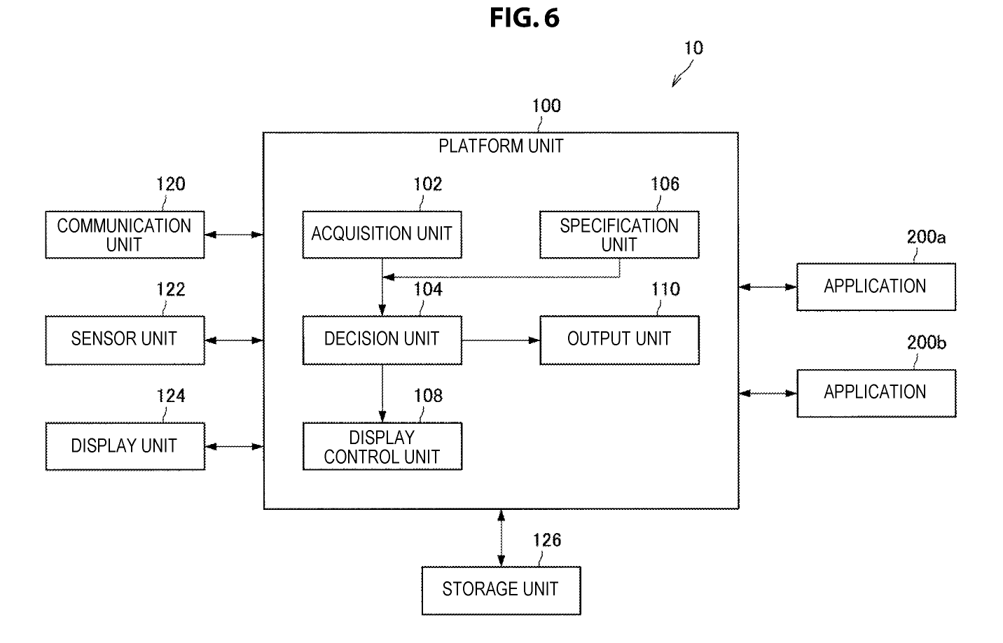

Next, a functional configuration according to the present embodiment will be described in detail. FIG. 6 is a function block diagram illustrating a functional configuration of the information processing system 10 according to the present embodiment. As illustrated in FIG. 6, the information processing system 10 includes a platform unit 100, a communication unit 120, the sensor unit 122, the display unit 124, a storage unit 126, and the applications 200. Note that in the following, description will be omitted for content similar to the description above.

### 2-1-1. Platform Unit 100

The platform unit 100 may include one or multiple processing circuits (such as the central processing unit (CPU) 150 described later, for example). The platform unit 100 centrally controls the operation of the information processing system 10. For example, the platform unit 100 uses the one or multiple processing circuits to realize the functions of an operating system (OS), middleware, and the like related to the information processing system 10. Also, as illustrated in FIG. 6, the platform unit 100 includes an acquisition unit 102, a decision unit 104, a specification unit 106, a display control unit 108, and an output unit 110,

### 2-1-2. Acquisition Unit 102

The acquisition unit 102 receives, or acquires by performing a readout process or the like, direction information related to the window 30 projected onto the screen 20 by the display unit 124. For example, the acquisition unit 102 acquires direction information related to the window 30 whose display mode is switched from the normal display mode to the full screen display mode among all windows 30 projected onto the screen 20 by the display unit 124. Herein, the direction information may indicate the current direction of the window 30 with respect to the screen 20.

Alternatively, the direction information may indicate the direction in which a user (for example, a user who performs an operation on the window 30) is positioned with respect to the screen 20. In this case, for example, the acquisition unit 102 acquires the direction information on the basis of a sensing result by the sensor unit 122. As an example, the acquisition unit 102 first acquires an image photographed by the sensor unit 122 as sensor data from the sensor unit 122 by receiving or performing a readout process or the like. Next, by performing image recognition on the image, the acquisition unit 102 recognizes the direction in which the user's hand (arm) is extended with respect to the screen 20, for example. Subsequently, the acquisition unit 102 acquires the recognized result as the direction information.

Alternatively, in the case in which the camera is capable of photographing even the surroundings of the screen 20, by performing image recognition with respect to the image photographed by the camera, the acquisition unit 102 may recognize individual users positioned around the screen 20 (such as each user who performs operations on the window 30, for example), and in addition, acquire the recognized result as the direction information. In this case, the direction information may indicate the directions in which individual users are positioned with respect to the screen 20, or the direction in which most users are positioned with respect to the screen 20.

Note that the image recognition may also be performed by the sensor unit 122 instead of the acquisition unit 102. Alternatively, via a communication network 54, the image may be transmitted to an external device (such as a server) able to communicate with the communication unit 120, and in addition, the external device may perform image recognition with respect to the image. In this case, the acquisition unit 102 may acquire a result of image recognition from the external device. Herein, the communication network 54 may include the Internet, any of various types of local area networks (LANs), and the like, for example.

### 2-1-3. Decision Unit 104

### 2-1-3-1. Deciding Direction and Size During Full Screen Display

The decision unit 104 decides the direction and size of the window 30 with respect to the screen 20 when the display mode of the window 30 projected onto the screen 20 is switched from the normal display anode to the full screen display mode, on the basis of the direction information acquired by the acquisition unit 102, and information related to the screen 20. Herein, the information related to the screen 20 includes the shape and size of the screen 20, for example. For example, the decision unit 104 decides the size of the window 30 when the display mode of the window 30 is switched from the normal display mode to the full screen display mode to be a value appropriate to the size of the screen 20.

### Decision Based on Current Direction of Window 30

Hereinafter, a decision example of deciding the direction and size of the window 30 when the display mode is switched to a full screen display mode will be described in further detail, For example, the decision unit 104 decides the direction and size of the window 30 with respect to the screen 20 when the display mode of the window 30 projected onto the screen 20 is switched to the full screen display mode, on the basis of the current direction of the window 30 with respect to the screen 20 (indicated by the direction information acquired by the acquisition unit 102). As one example, on the basis of the direction information, the decision unit 104 decides the direction of the window 30 with respect to the screen 20 in the full screen display mode to be a direction in units of 90 degrees (for example, a value rounded to units of 90 degrees). More specifically, in the case in which the current rotational angle of the window 30 is “equal to or greater than −45 degrees, but less than 45 degrees”, the decision unit 104 decides the rotational angle of the window 30 when the display mode is switched to the full screen display mode to be “0 degrees”. Also, in the case in which the current rotational angle of the window 30 is “equal to or greater than 45 degrees, but less than 135 degrees”, the decision unit 104 decides the rotational angle of the window 30 when the display mode is switched to the full screen display mode to be “90 degrees”. Also, in the case in which the current rotational angle of the window 30 is “equal to or greater than 135 degrees, but less than 225 degrees”, the decision unit 104 decides the rotational angle of the window 30 when the display mode is switched to the full screen display mode to be “180 degrees”. Also, in the case in which the current rotational angle of the window 30 is “equal to or greater than 225 degrees, but less than 315 degrees”, the decision unit 104 decides the rotational angle of the window 30 when the display mode is switched to the full screen display mode to be “270 degrees”. According to these decision examples, in the case in which the screen 20 is rectangular, for example, inconsistencies are not produced between the shape of the screen 20 and the shape of the window 30 during full screen display.

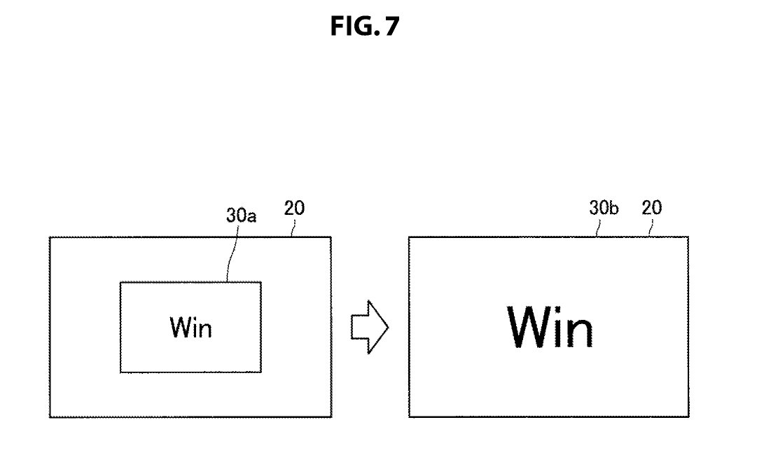

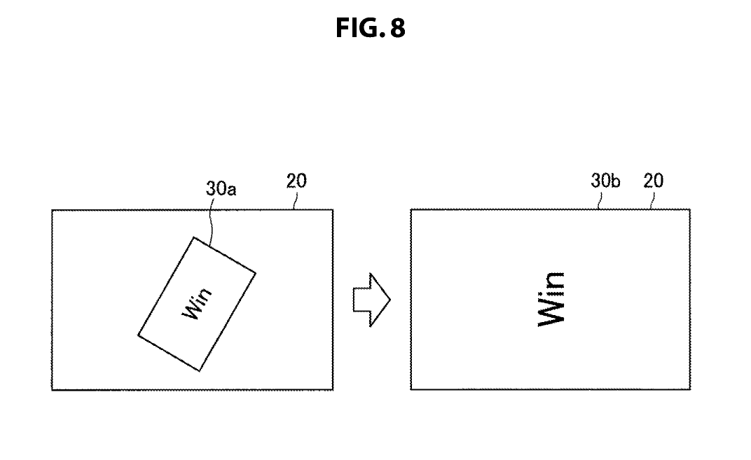

At this point, the above function will be described in further detail with reference to FIGS. 7 to 13. Note that FIGS. 7 and 8 are explanatory diagrams illustrating decision examples of deciding the direction and size of the window 30 when the display mode is switched to a full screen display mode, in the case in which the screen 20 and the window 30 are rectangular.

### Decision Example 1

FIG. 7 illustrates an example in which the rotational angle of the window 30a with respect to the screen 20 is “0 degrees” when the display mode of the window 30a is the normal display mode (in other words, a case in which the x-axis direction and the y-axis direction of the window 30a are parallel to the x-axis direction and the y-axis direction of the screen 20, respectively). In this case, when the display mode of the window 30a is switched from the normal display mode to the full screen display mode, as illustrated in FIG. 7, the decision unit 104 decides the rotational angle of the window 30b after switching to be the same as the current rotational angle of the window 30a (that is, “0 degrees”), and in addition, decides the size of the window 30b after switching to be the size of the screen 20 (or the size at which the window 30b is enlarged to be inscribed in the screen 20).

Also, FIG. 8 illustrates an example in which the rotational angle of the window 30a with respect to the screen 20 is “equal to or greater than 45 degrees, but less than 135 degrees” when the display mode of the window 30a is the normal display mode. In this case, when the display mode of the window 30a is switched from the normal display mode to the full screen display mode, as illustrated in FIG. 8, the decision unit 104 decides the rotational angle of the window 30b after switching to be “90 degrees”, and in addition, decides the size of the window 30b after switching to be the size of the screen 20 (or the size at which the window 30b is enlarged to be inscribed in the screen 20).

### Decision Example 2

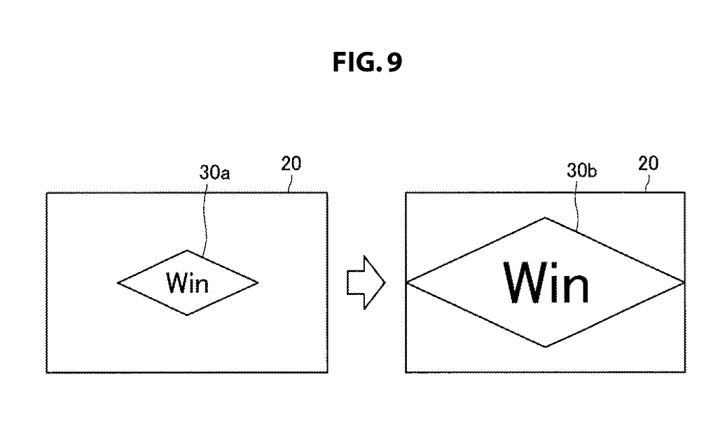

Also, FIGS. 9 to 11 are explanatory diagrams illustrating decision examples of deciding the direction and size of the window 30 when the display mode is switched to a full screen display mode, in the case in which the screen 20 is rectangular, and the window 30 is non-rectangular. Note that FIGS. 9 to 11 illustrate an example in which the rotational angle of the window 30a with respect to the screen 20 is “0 degrees” when the display mode of the window 30a is the normal display mode. In this case, when the display mode of the window 30a is switched from the normal display mode to the full screen display mode, as illustrated in FIG. 9, the decision unit 104 may decide the rotational angle of the window 30b after switching to be “0 degrees”, and in addition, may decide the size of the window 30b after switching to be the size enlarged to be inscribed in the screen 20.

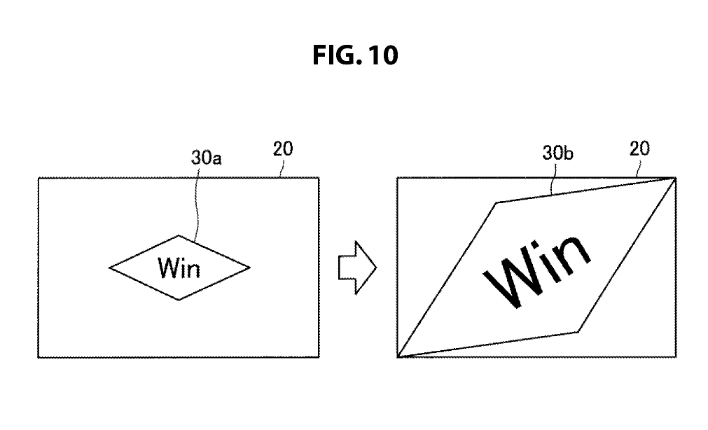

Alternatively, as illustrated in FIG. 10, the decision unit 104 may also decide a rotational angle at which the size of the window 30 is maximized within the range of the window 30 fitting inside the screen 20 as the rotational angle of the window 30b after switching. Additionally, the decision unit 104 may also decide a size at which the window 30 is enlarged to be inscribed in the screen 20 at the rotational angle as the size of the window 30b after switching.

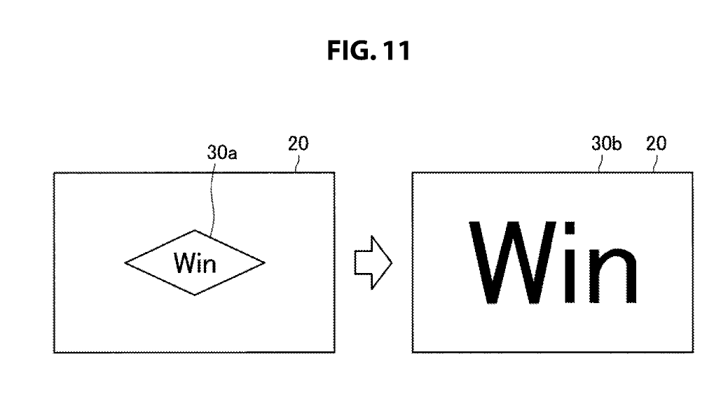

Alternatively, in the case in which the application 200 corresponding to the window 30 supports displaying the window 30 with a rectangular layout, as illustrated in FIG. 11, the decision unit 104 may decide the rotational angle of the window 30b after switching to be “0 degrees”, and in addition, may decide the size of the window 30b after switching to be the size of the screen 20. Note that in this case, when the display mode is switched to the full screen display mode, as illustrated in FIG. 11, the application 200 may draw the window 30b transformed into a rectangular layout.

### Decision Example 3

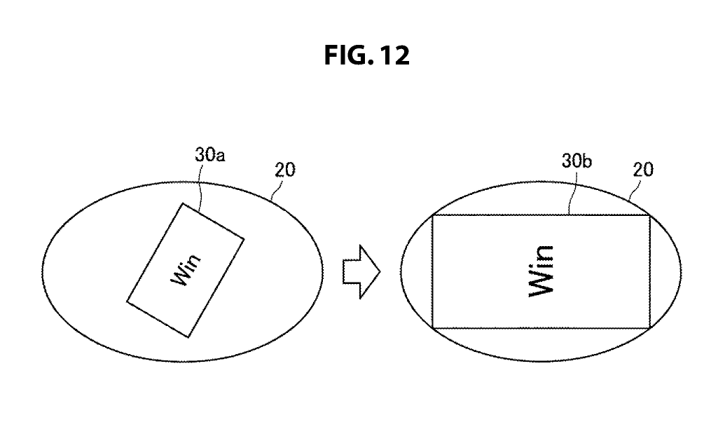

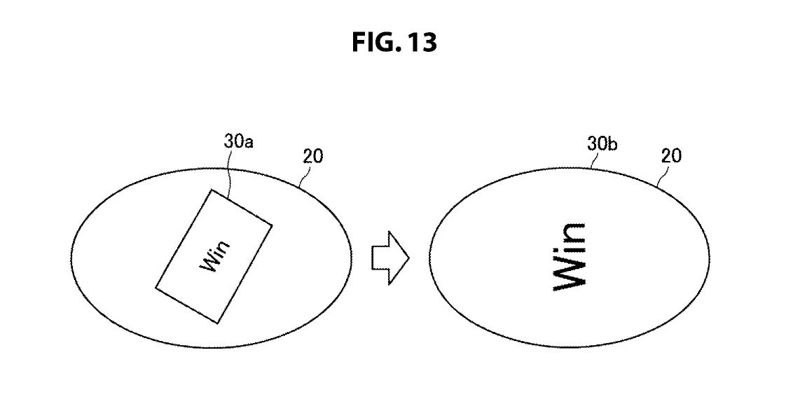

Also, FIGS. 12 and 13 are explanatory diagrams illustrating decision examples of deciding the direction and size of the window 30 when the display mode is switched to a full screen display mode, in the case in which the screen 20 is non-rectangular, and the window 30 is non-rectangular. Note that FIGS. 12 and 13 illustrate an example in which the rotational angle of the window 30a with respect to the screen 20 is “equal to or greater than 45 degrees, but less than 135 degrees” when the display mode of the window 30a is the normal display mode.

In this case, when the display mode of the window 30a is switched from the normal display mode to the full screen display mode, as illustrated in FIG. 12, the decision unit 104 may decide the rotational angle of the window 30b after switching to be “90 degrees”, and in addition, may decide the size of the window 30b after switching to be the maximum rectangular size inscribed in the screen 20.

Alternatively, in the case in which the application 200 corresponding to the window 30 supports displaying the window 30 with a non-rectangular layout, as illustrated in FIG. 13, the decision unit 104 may decide the rotational angle of the window 30b after switching to be “90 degrees”, and in addition, may decide the size of the window 30b after switching to be the size of the screen 20, Note that in this case, when the display mode is switched to the full screen display mode, as illustrated in FIG, 13, the application 200 may draw the window 30b transformed into a layout (non-rectangular layout) corresponding to the shape of the screen 20.

### Decision Based on Direction in Which User is Positioned

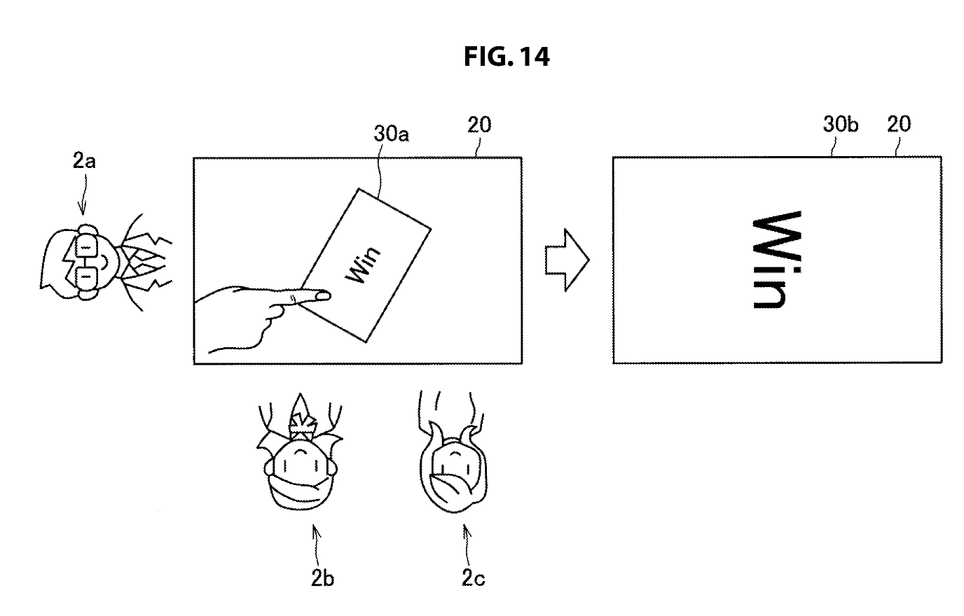

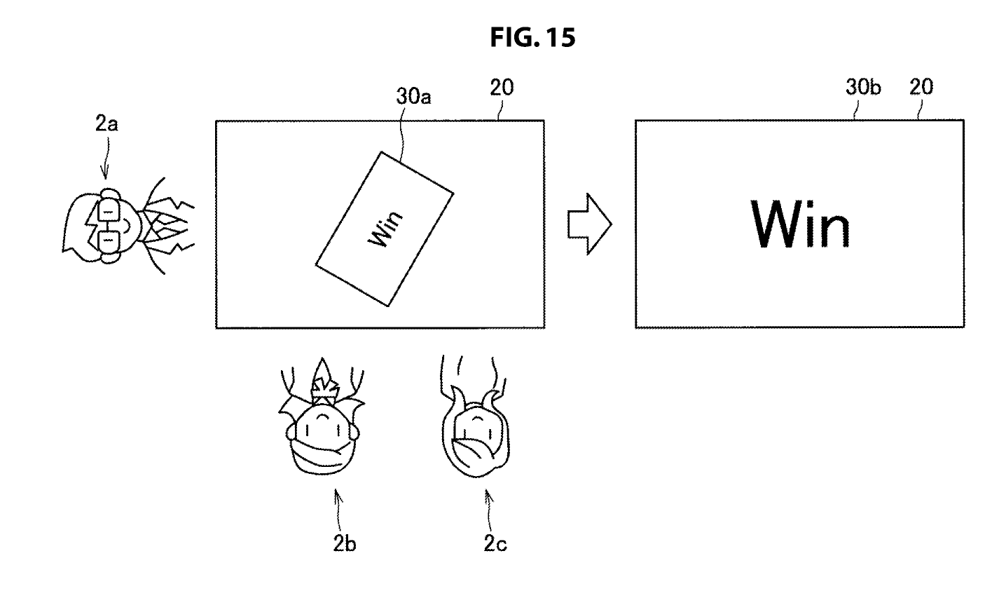

Also, the decision unit 104 is also capable of deciding the direction and size of the window 30 with respect to the screen 20 when the display mode of the window 30 projected onto the screen 20 is switched from the normal display mode to the full screen display mode, on the basis of a direction in which users are positioned with respect to the screen, which is indicated by the direction information acquired by the acquisition unit 102. At this point, the above function will be described in further detail with reference to FIGS. 14 and 15. Note that FIGS. 14 and 15 are explanatory diagrams illustrating other decision examples of deciding the direction and size of the window 30 when the display mode is switched to a full screen display mode, in the case in which the screen 20 and the window 30 are rectangular.

### Decision Example 1

For example, as illustrated in FIG. 14, the decision unit 104 may decide the direction of the window 30 with respect to the screen 20 when the display mode of the window 30 projected onto the screen 20 is switched from the normal display mode to the full screen display mode, in accordance with the direction in which a user operating the window 30 (in the example illustrated in FIG. 14. the user 2a) is positioned. For example, when the display mode of the window 30a is switched from the normal display mode to the full screen display mode, as illustrated. in FIG. 14, the decision unit 104 first decides the direction (rotational angle) of the window 30b after switching to be a value obtained by rounding, to units of 90 degrees, for example, the direction in which the user operating the window 30 is facing the screen 20. Additionally, the decision unit 104 may also decide the size of the window 30 to be the size of the screen 20 (or a size at which the window 30b is enlarged to be inscribed in the screen 20).

### Decision Example 2

Alternatively, as illustrated in FIG. 15, the decision unit 104 may decide the direction of the window 30 with respect to the screen 20 when the display mode of the window 30 is switched from the normal display mode to the full screen display mode, in accordance with the direction in which most users are positioned with respect to the screen 20. For example, when the display mode of the window 30a is switched from the normal display mode to the full screen display mode, as illustrated in FIG. 15, the decision unit 104 first decides the direction (rotational angle) of the window 30b after switching to be a value obtained by rounding, to units of 90 degrees, for example, the direction in which most users are facing the screen 20. Additionally, the decision unit 104 may also decide the size of the window 30 to be the size of the screen 20 (or a size at which the window 30b is enlarged to be inscribed in the screen 20).

### Deciding Size That Avoids Object on Screen 20

Also, the decision unit 104 is also capable of deciding the direction and size of the window 30 when the display mode of the window 30 projected onto the screen 20 is switched from the normal display mode to the full screen display mode, on the basis of a specification result regarding the presence or absence of an object on the screen 20 by the specification unit 106 described later. For example, the decision unit 104 decides the direction and size of the window 30 when the display mode of the window 30 is switched to the full screen display mode in accordance with a region other than the region of an object placed on the screen 20, which is specified by the specification unit 106.

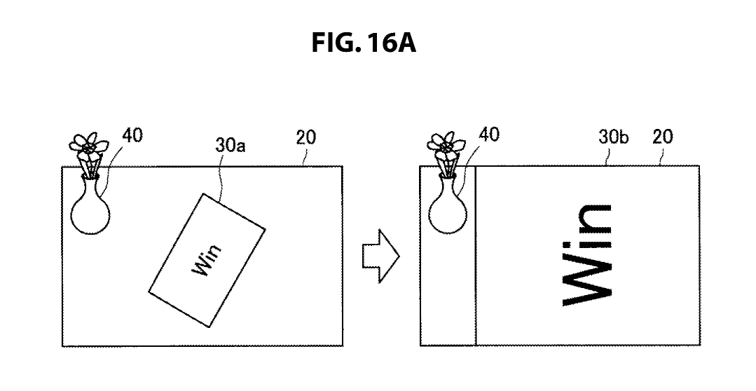

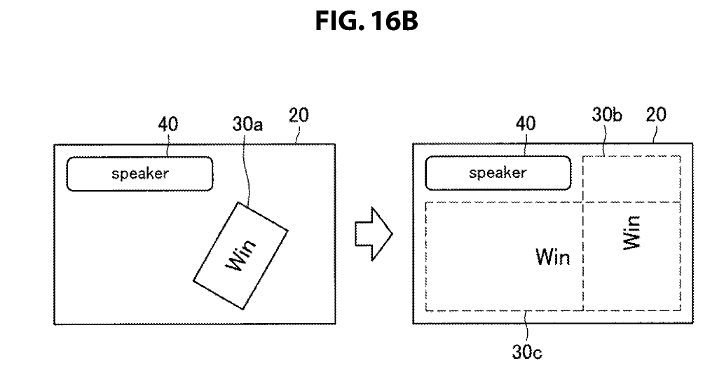

At this point, the above function will be described with reference to FIGS. 16A and 16B. Note that FIGS. 16A and 16B illustrate an example in which the rotational angle of the window 30a with respect to the screen 20 is “equal to or greater than 45 degrees, but less than 135 degrees” when the display mode of the window 30a is the normal display mode. For example, when the display mode of the window 30a is switched from the normal display mode to the full screen display mode, as illustrated in FIG. 16A, the decision unit 104 may decide the rotational angle of the window 30b after switching to be “90 degrees”, and in addition, may decide the maximum rectangular size inside the screen 20 that does not include the region of an object 40 recognized as being placed on the screen 20 as the size of the window 30b after switching.

Note that, as illustrated in FIG. 16B, depending on the shape and size of the object 40 recognized as being placed on the screen 20, the size of the maximum rectangle 30c inside the screen 20 that does not include the region of the object 40 in the case of setting the rotational angle of the window 30 to another angle (in the example illustrated in FIG. 16B, “0 degrees”) may be larger than the size of the window 30b after switching according to the above decision method. Accordingly, in this case, when the display mode of the window 30a is switched to the full screen display mode, the decision unit 104 may decide the rotational angle of the window 30 after switching to be the other angle (“0 degrees”), and in addition, may decide the size of the window 30 after switching to be the size of the maximum rectangle 30c inside the screen 20 that does not include the object 40. In other words, the decision unit 104 may decide the rotational angle of the window 30 during full screen display by giving the size of the window 30 during full screen display a higher priority (than the rotational angle during normal display).

Alternatively, in the example illustrated in FIG. 16B, the information processing system 10 may project a display preview of the window 30b illustrated in FIG. 16B and a display preview of the window 30c illustrated in FIG. 16B onto the screen 20, and one of the two display previews of the window 30 may be selected by a user. In this case, the decision unit 104 may decide each of the rotational angle and the size of the window 30 when the display mode is switched to the full screen display mode to be the rotational angle and size corresponding to the display preview selected by a user from among the two display previews of the window 30.

### Modification 1

Note that although the above description describes an example of deciding the rotational angle of the window 30 with respect to the screen 20 when the display mode of the window 30 is switched to the full screen display mode to be a value obtained by rounding the current rotational angle of the window 30 to units of 90 degrees, the configuration is not limited to such an example. As a modification, the decision unit 104 may also decide the rotational angle of the window 30 when the display mode is switched to the full screen display mode to be a value obtained by rounding the rotational angle of the window 30 during the normal display mode to units of 180 degrees. In this case, since the shape of the window 30 during full screen display (such as the numbers of vertical and horizontal pixels, for example) becomes constant, the implementation of the platform unit 100 can be simplified, for example.

### Modification 2

Also, as another modification, the rotational angle of the window 30 with respect to the screen 20 when the window 30 is displayed in full screen may also be changeable by a user on demand. For example, the rotational angle of the window 30 during full screen display may be changeable by a user with an operation on a predetermined GUI projected in association with the window 30, a gesture (such as a touch operation), a speech command, or the like.

### 2-1-3-2. Reversion to Normal Display Mode

Also, When the display mode of the window 30 is switched (reverted) from full screen mode to normal display mode, the decision unit 104 is capable of changing each of the direction and the size of the window 30 with respect to the screen 20 to the direction and the size of the window 30 from immediately before being switched to the full screen display mode. For example, when the display mode of the window 30 is switched from the full screen display mode to the normal display mode, the decision unit 104 first decides the direction of the window 30 after switching to be the direction of the window 30 with respect to the screen 20 from immediately before being switched to the full screen display mode, which is stored in the storage unit 126 described later. Furthermore, the decision unit 104 decides the size of the window 30 after switching to be the size of the window 30 from immediately before being switched to the full screen display mode, which is stored in the storage unit 126.

### 2-1-3-3. Target of Full Screen Display

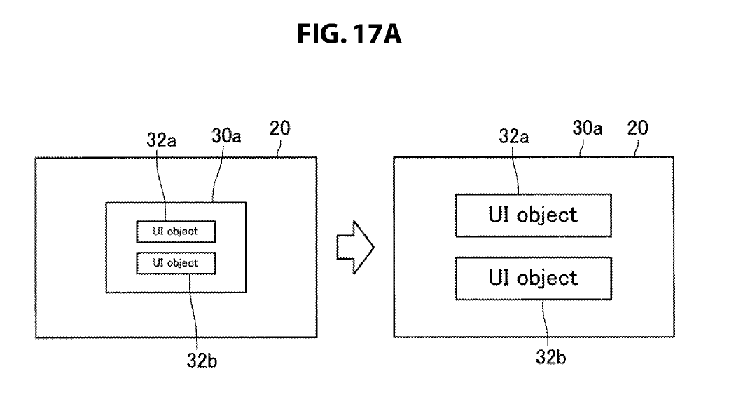

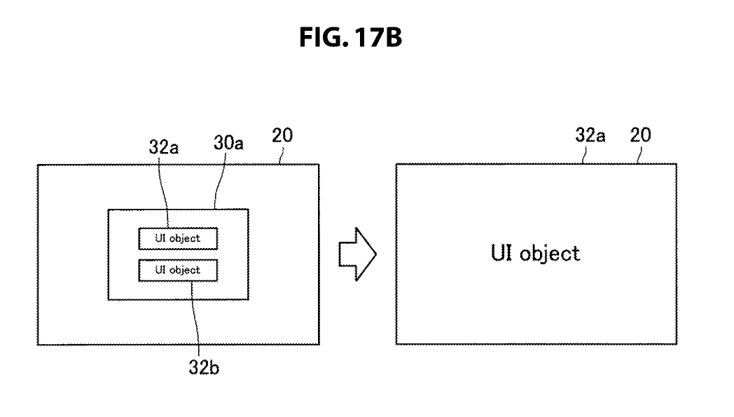

Note that, as described earlier, the window 30 may include at least one UI object 32. In this case, when the display mode of the window 30 is switched from the normal display mode to the full screen display mode, the entire window 30 may be displayed in full screen as illustrated in FIG. 17A, or one of the UI objects 32 inside the window 30 may be displayed in full screen as illustrated in FIG. 17B. Note that regarding the case in which a UI object 32 is displayed in full screen, the UI object 32 targeted for full screen display may be a UI object 32 selected by a user (in the window 30), or a UI object 32 predetermined for each window 30. Note that, for example, the UI object 32 targeted for full screen display may be selected by a user with an operation on a predetermined GUI included in the UI object 32, a gesture (such as a touch operation), a speech command, or the like.

### 2-1-3-4. Display Modes

Also, the display modes of the window 30 additionally may include a full window display mode (in addition to the normal display mode and the full screen display mode). Herein, the full window display mode is a display mode in which, in the case in which the window 30 includes at least one UI object 32, one of the at least one UI objects 32 is displayed enlarged up to a size inscribed in the current window 30.

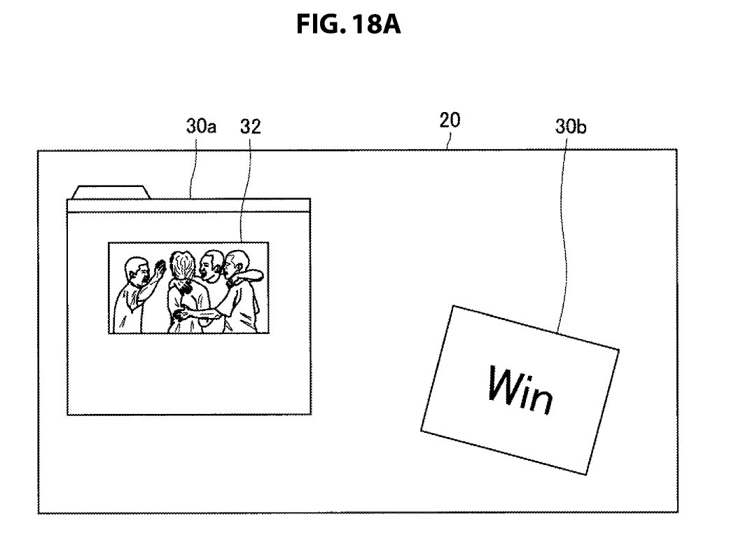

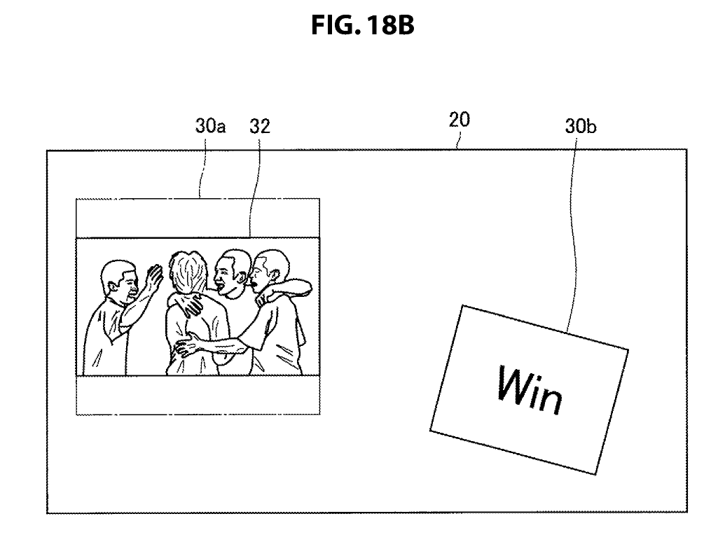

For example, when a UI object 32 included in the 30a as illustrated in FIG. 18A is switched from the normal display mode to the full window display mode, as illustrated in FIG. 18B, the application 200 corresponding to the window 30a enlarges the size of the UI object 32 to a size inscribed in the window 30a, and in addition, changes the layout of the window 30a to display only the UI object 32. According to this display example, the display size of the UI object 32 can be enlarged without changing the size of the window 30 itself. For this reason, a user currently operating the window 30 can enlarge and view the UI object 32. Also, since the size of the window 30 itself does not change, other windows 30 projected onto the screen 20 are unaffected. Consequently, for example, other users who are viewing and operating the other windows 30 are unaffected.

Note that when the display mode of the window 30 is switched from the normal display mode to the full window display mode, as illustrated in FIG. 18B, the platform unit 100 basically does not change the position, direction, and size of the window 30.

Note that whether or not the display modes of individual windows 30 are switchable to the full window display mode may also be predetermined for each application 200 corresponding to the windows 30. Alternatively, for each window 30, whether or not the display mode is switchable to the full window display mode may be changeable on demand by a user. Note that while the display mode of the window 30 is the full window display mode, the display mode may also be switchable (from the full window display mode) to either of the normal display mode and the full screen display mode.

### 2-1-4. Specification Unit 106

The specification unit 106 specifies the presence or absence of an object placed on the screen 20, on the basis of a sensing result with respect to the screen 20. Furthermore, in the case of recognizing that an object is present, the specification unit 106 specifies a region in which the object is placed on the screen 20, on the basis of the sensing result. For example, on the basis of a result of image recognition (including object recognition) with respect to an image in which the screen 20 is imaged, a result of sensing with respect to the screen 20, or the like, the specification unit 106 specifies the presence or absence of an object on the screen 20, and in the case of recognizing that an object is present, specifies the region in which the object is placed on the screen 20.

Note that the image recognition may be performed by the specification unit 106, or by the sensor unit 122. Alternatively, via a communication network 54, the image may be transmitted to an external device (such as a server) able to communicate with the communication unit 120, and in addition, the external device may perform image recognition with respect to the image. In this case, the specification unit 106 may acquire a result of image recognition from the external device.

### 2-1-5. Display Control Unit 108

The display control unit 108 controls the projection by the display unit 124. For example, the display control unit 108 causes the display unit 124 to project a display object onto the screen 20, with the direction of the display object decided by the decision unit 104. As an example, when the display mode of the window 30 is switched from the normal display mode to the full screen display mode, and when the display mode of the window 30 is switched from the full screen display mode to the normal display mode, the display control unit 108 updates the display content with respect to the screen 20 as a whole, and additionally causes the display unit 124 to project the updated display content.

### 2-1-6. Output Unit 110

When the display mode of the window 30 is switched from the normal display mode to the full screen display mode, the output unit 110 outputs the size of the window 30 after switching to the application 200 corresponding to the window 30. At this time, the output unit 110 additionally may output the direction (such as the rotational angle) of the window 30 after switching to the application 200 corresponding to the window 30.

Also, when the display mode of the window 30 is switched from the full screen display mode to the normal display mode, the output unit 110 outputs the size of the window 30 after switching to the application 200 corresponding to the window 30. At this time, the output unit 110 additionally may output the direction of the window 30 after switching to the application 200 corresponding to the window 30.

### 2-1-7. Communication Unit 120

The communication unit 120 transmits and receives information to and from an external device through the communication network 54, for example.

### 2-1-8. Storage Unit 126

The storage unit 126 stores various types of data and various types of software. For example, the storage unit 126 stores the position of the window 30 on the screen 20, the direction of the window 30 with respect to the screen 20, and the size of the window 30 from immediately before when the display mode of the window 30 is switched from the normal display mode to the full screen display mode (for example, until the display mode of the window 30 is reverted to the normal display mode).

### 2-1-9. Application 200

The application 200 performs a process of drawing at least one window 30 corresponding to the application 200. For example, when the display mode of the window 30 is switched from the normal display mode to the full screen display mode, the application 200 corresponding to the window 30 changes the layout of the window 30 to conform to the size of the window 30 during the full screen display mode output by the output unit 110, and additionally updates the drawing of the window 30. Also, when the display mode of the window 30 is switched from the full screen display mode to the normal display mode, the application 200 corresponding to the window 30 changes the layout of the window 30 to conform to the size of the window 30 during the normal display mode output by the output unit 110, and additionally updates the drawing of the window 30.

Note that the application 200 may also be processed by a processor or the like different from the display control unit 108 (or the decision unit 104). Alternatively, in the case in which the display control unit 108 (or the decision unit 104) is capable of executing processes other than the processes for acting as the platform unit 100, the display control unit 108 (or the decision unit 104) may execute the processes of the application 200.

### 2-2. Process Flows

The above describes a functional configuration according to the present embodiment. Next, process flows according to the present embodiment will be described in “2-2-1. Flow of processes when switching from normal display to enlarged display” and “2-2-2. Flow of processes when switching from full screen display to normal display”.

### 2-2-1. Flow of Processes When Switching from Normal Display to Enlarged Display

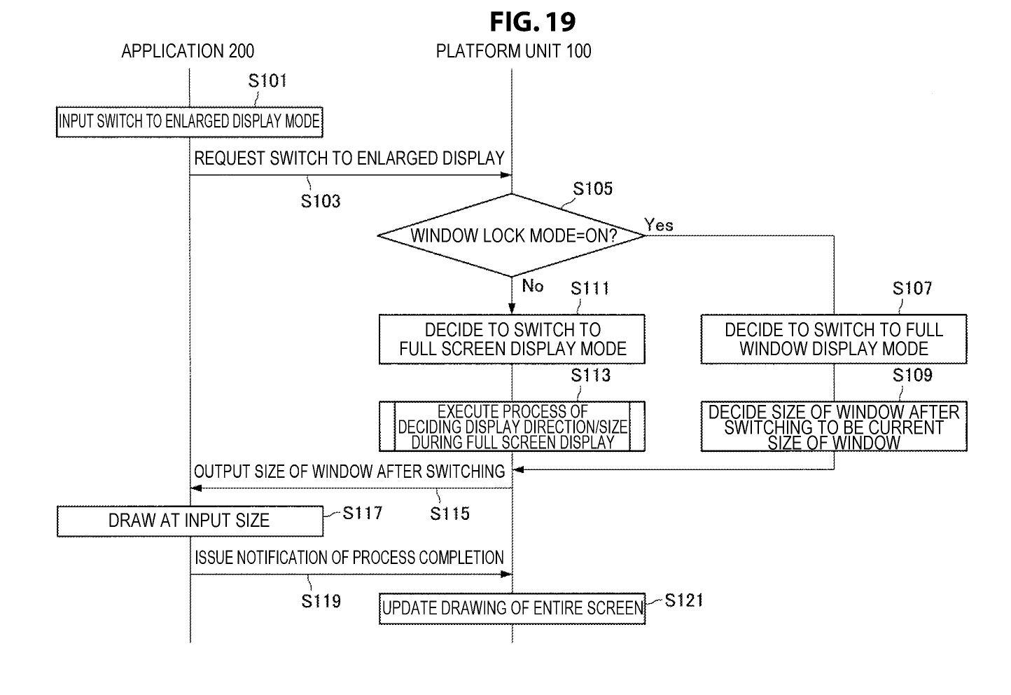

First, a “flow of processes when switching from a normal display to an enlarged display” will be described with reference to FIG. 19. FIG. 19 is a sequence diagram illustrating the “flow of processes when switching from a normal display to an enlarged display”. Note that the following describes an example in which the screen 20 and the window 30 are rectangular.

As illustrated in FIG. 19, first, a user performs input for switching the display mode of one of the windows 30 projected onto the screen 20 by the display unit 124 from the normal display mode to the full screen display mode or the full window display mode. Note that, for example, the input may be performed by an operation with respect to a predetermined GUI (such as a button) included in the individual windows 30, a predetermined gesture (such as a predetermined touch operation), a predetermined speech command, or the like (S101).

After that, the application 200 corresponding to the window 30 requests the platform unit 100 to switch the window 30 to the full screen display (or the full window display mode). For example, the application 200 calls an application programming interface (API) for requesting the platform unit 100 to switch the window 30 to the full screen display (or the full window display mode) (S103).

After that, the decision unit 104 of the platform unit 100 confirms whether or not a window lock mode associated with the window 30 is on (S105). In the case in which the window lock mode is on (S105: Yes), first, the decision unit 104 decides to switch the display mode of the window 30 to the full window display mode (S107). Subsequently, the decision unit 104 decides the size of the window 30 after switching to be the size of the window 30 during the normal display mode (S109). After that, the platform unit 100 performs the process of S115 described later.

On the other hand, in the case in which the window lock mode is off (S105: No), the decision unit 104 decides to switch the display mode of the window 30 to the full screen display mode (S111). Subsequently, the decision unit 104 performs the “process of deciding the display direction/size during full screen display” described later (S113).

Next, the output unit 110 outputs the size of the window 30 after the switching of the display mode decided in S109 or S113 to the application 200 (S115).

After that, the application 200 changes the layout of the window 30 on the basis of the size input in S115, and in addition, updates the drawing of the window 30 (S117). Subsequently. the application 200 notifies the platform unit 100 of the completion of processing (S119).

After that, the display control unit 108 of the platform unit 100 updates the drawing with respect to the screen 20 as a whole, and in addition, causes the display unit 124 to project the updated display content (S121).

### 2-2-1-1. Process of Deciding Display Direction/Size During Full Screen Display

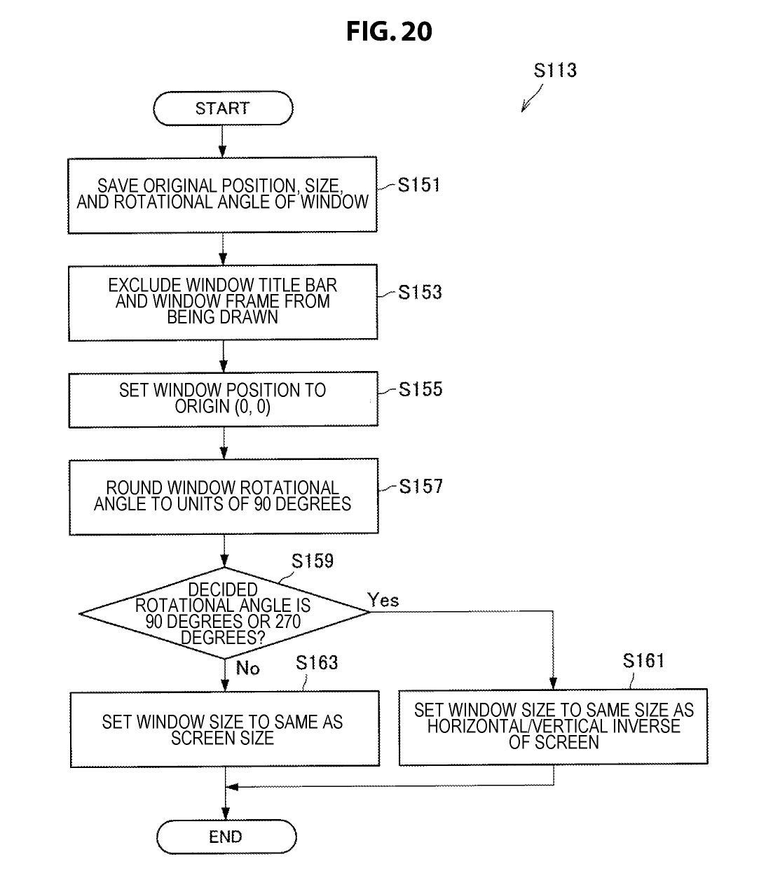

Herein, the flow of the “process of deciding the display direction/size during full screen display” in S113 will be described in detail with reference to FIG. 20. As illustrated in FIG. 20, first, the decision unit 104 records the current (that is, immediately before the display mode is switched to the full screen display mode) position of the window 30 on the screen 20, the size of the window 30, and the direction of the window 30 with respect to the screen 20, in the storage unit 126 (S151).

Next, the decision unit 104 sets the title bar and window frame of the window 30 to outside the drawing target during full screen display (S153).

Next, the decision unit 104 sets the position of the window 30 when the display mode is switched to the full screen display mode to the origin (0, 0) (S155).

Next, the decision unit 104 decides the rotational angle of the window 30 with respect to the screen 20 when the display mode is switched to the full screen display mode to be a value obtained by rounding the current rotational angle to units of 90 degrees (S157).

Next, the decision unit 104 determines whether or not the rotational angle decided in S157 is “90 degrees” or “270 degrees” (S159). In the case in which the decided rotational angle is “90 degrees” or “270 degrees” (S159: Yes), the decision unit 104 decides the size of the window 30 when the display mode is switched to the full screen display mode to be a size that is the horizontal and vertical inverse of the screen 20 (S161). Subsequently, the process ends.

In the case in which the decided rotational angle is not “90 degrees” or “270 degrees” (that is, in the case of “0 degrees” or “180 degrees”) (S159: No), the decision unit 104 decides the size of the window 30 when the display mode is switched to the full screen display mode to be the same size as the size of the screen 20 (S163). Subsequently, the process ends.

### 2-2-2. Flow of Processes When Switching From Full Screen Display to Normal Display

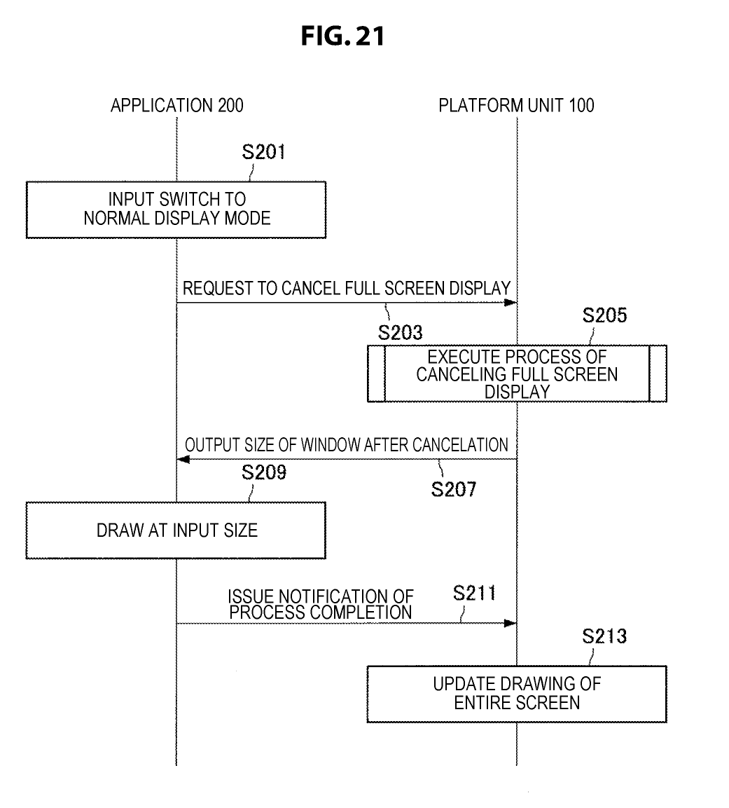

Next, the “flow of processes when switching from the full screen display to the normal display” will be described with reference to FIG. 21. FIG. 21 is a sequence diagram illustrating the “flow of processes when switching from the full screen display to the normal display”. Note that in the following, the flow of processes will be described for a situation in which the window 30 is being displayed in the full screen display mode. Also, an example in which the screen 20 and the window 30 are rectangular will be described.

As illustrated in FIG. 21, first, a user performs input for switching the display mode of the window 30 being displayed in full screen to the normal display mode. Note that, for example, the input may be performed by an operation with respect to a predetermined GUI (such as a button) included in the window 30 during full screen display, a predetermined gesture (such as a predetermined touch operation), a predetermined speech command, or the like (S201).

After that, the application 200 corresponding to the window 30 requests the platform unit 100 to switch the display mode of the window 30 from the full screen display mode to the normal display mode. For example, the application 200 calls an API for requesting the platform unit 100 to cancel the full screen display of the window 30 (S203).

After that, the platform unit 100 performs a “process of canceling the full screen display” described later (S205).

Next, the output unit 110 of the platform unit 100 outputs the size of the window 30 decided in S205 to the application 200 (S207).

After that, the application 200 changes the layout of the window 30 on the basis of the size input in S207, and in addition, updates the drawing of the window 30 (S209). Subsequently, the application 200 notifies the platform unit 100 of the completion of processing (S211).

After that, the platform unit 100 updates the drawing with respect to the screen 20 as a whole, and in addition, causes the display unit 124 to project the updated display content (S213).

### 2-2-2-1. Process of Canceling Full Screen Display

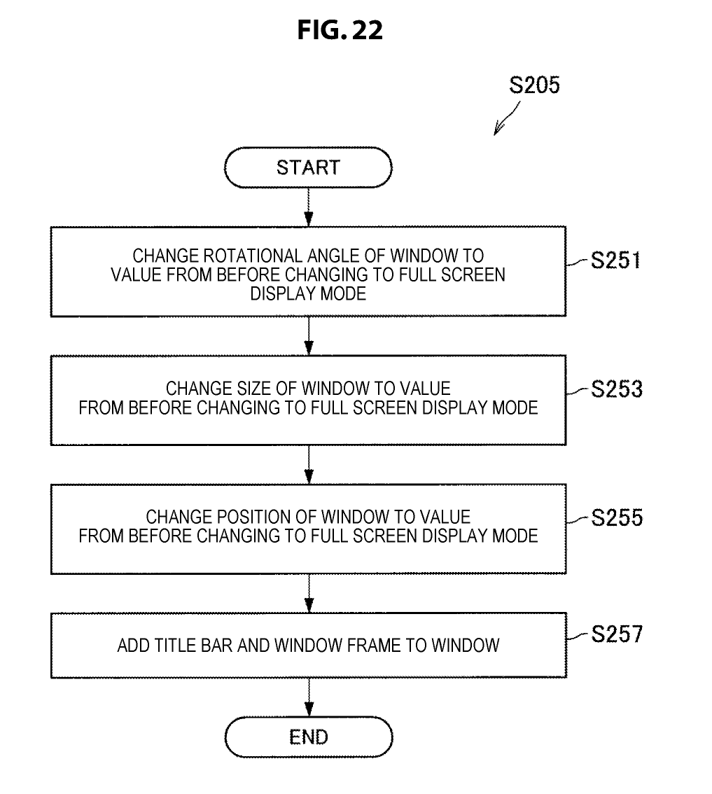

Herein, the flow of the “process of canceling the full screen display” in S205 will be described in detail with reference to FIG. 22. As illustrated in FIG. 22, first, the decision unit 104 decides the rotational angle of the window 30 with respect to the screen 20 when the display mode is switched from the full screen display mode to the normal display mode to be the rotational angle of the window 30 (from immediately before the display mode is switched to the full screen display mode) which is stored in the storage unit 126 (S251).

Next, the decision unit 104 decides the size of the window 30 when the display mode is switched from the full screen display mode to the normal display mode to be the size of the window 30 (from immediately before the display mode is switched to the full screen display mode) which is stored in the storage unit 126 (S253).

Next, the decision unit 104 decides the position of the window 30 on the screen 20 when the display mode is switched from the full screen display mode to the normal display mode to be the position of the window 30 (from immediately before the display mode is switched to the full screen display mode) which is stored in the storage unit 126 (S255).

After that, the decision unit 104 decides to cause the window 30 to be displayed with the addition of the title bar and the window frame when the display mode is switched from the full screen display mode to the normal display mode (S257).

### 2-3. Effects

### 2-3-1. Effect 1

As described above, the platform unit 100 according to the present embodiment acquires direction information indicating a rotational angle of a display object displayed on a display screen, the rotational angle being with respect to a reference angle on the display screen, or a direction in which a user is positioned with respect to the display screen, and in addition, decides, on the basis of the direction information, the direction of the display object with respect to the display screen when the display mode of the display object is switched to an enlarged display mode. For this reason, the direction of the display object can be decided appropriately when the display mode of the display object is switched to the enlarged display mode.

For example, even in the case in which the window 30 is displayed in full screen while still being rotated with respect to the screen 20, the window 30 can be displayed in full screen on the screen 20 to match the size of the screen 20. Also, the platform unit 100 can realize full screen display of the window 30 that conforms to the shape of the screen 20 and the characteristics of the equipment. Consequently, the usefulness of the equipment can be improved.

### 2-3-2. Effect 2

Also, according to the present embodiment, for example, the direction and size of the window 30 when the display mode is switched to the full screen display mode are decided not by the application 200, but by the platform unit 100 In other words, it is not necessary that the application 200 judge whether or not the equipment enables omnidirectional operations. For this reason, it is not necessary to build in special functions in the application 200. Consequently, excess costs are not imposed on the creation of the application 200.

Also, for similar reasons, in the information processing system 10, existing applications 200 can be utilized as-is. Furthermore, even in the case in which equipment of a new form appears in the future, since the platform unit 100 can correct the direction and size (during full screen display) according to the form of the equipment, there is an advantage in that it is not necessary to correct existing applications 200.

### 3. Hardware Configuration

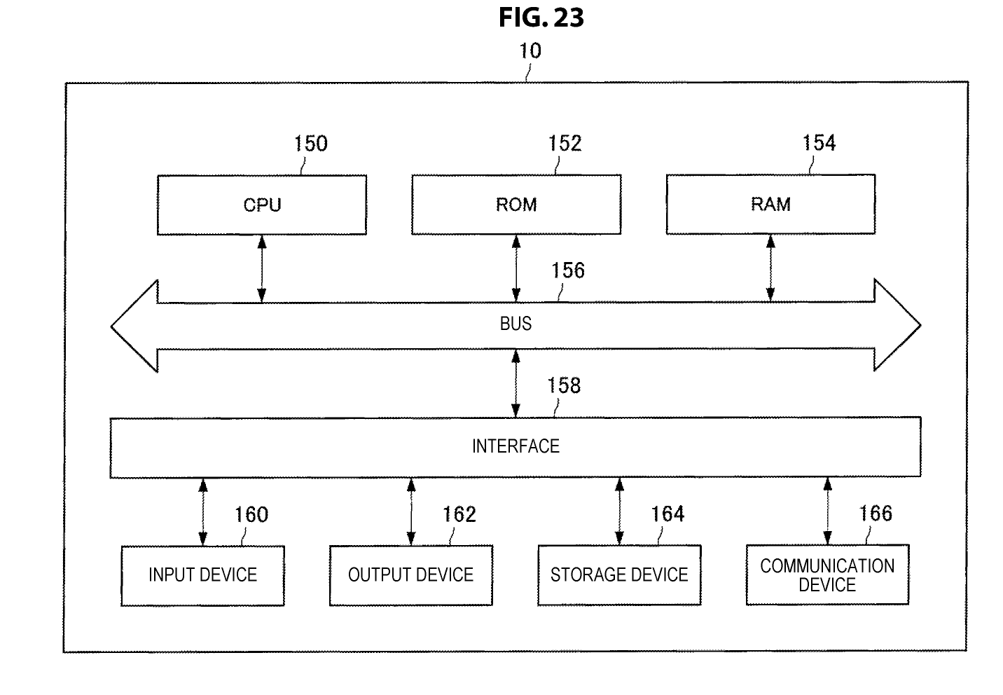

Next, a hardware configuration of the information processing system 10 according to the present embodiment is described with reference to FIG. 23. As illustrated in FIG. 23, the information processing system 10 includes a CPU 150, read only memory (ROM) 152, random access memory (RAM) 154, a bus 156, an interface 158, an input device 160, an output device 162, a storage device 164, and a communication device 166.

The CPU 150 functions as a computational processing device and a control device, and controls the overall operation in the information processing system 10 in accordance with various programs. In addition, the CPU 150 realizes the function of the platform unit 100 in the information processing system 10. Moreover, the CPU 150 includes a processor such as a microprocessor.

The ROM 152 stores programs and data for control and the like such as operation parameters, which are used by the CPU 150.

The RAM 154 temporarily stores, for example, programs and the like executed by the CPU 150.

The bus 156 includes a CPU bus and the like. This bus 156 connects the CPU 150, the ROM 152, and the RAM 154 to each other.

The interface 158 connects the bus 156 to the input device 160, the output device 162, the storage device 164, and the communication device 166.

The input device 160 includes, for example, an input mechanism for a user to input information, such as a touch panel, a button, a switch, a dial, a lever, or a microphone, an input control circuit, which generates an input signal on the basis of the input by the user and outputs the input signal to the CPU 150, and the like.

The output device 162 includes, for example, a display device such as a projector, a liquid crystal display device, an organic light emitting diode (OLED) device, or a lamp. In addition, the output device 162 includes an audio output device such as a speaker. The output device 162 can realize the function of the display unit 124 in in the information processing system 10.

The storage device 164 is a device for data storage. The storage device 164 includes, for example, a storage medium, a recording device that records data in the storage medium, a reading device that reads data from the storage medium, a deletion device that deletes data recorded in the storage medium, or the like. This storage device 164 can realize the function of the storage unit 126 in the information processing system 10.

The communication device 166 is a communication interface including, for example, a communication device or the like for connection to the communication network 54. In addition, the communication device 166 may be a wireless LAN compatible communication device, a Long-Term Evolution (LTE) compatible communication device, or a wire communication device that performs wired communication. This communication device 166 can realize the function of the communication unit 120 in the information processing system 10.

### 4. Modifications

It should be understood by those skilled in the art that various modifications, combinations, sub-combinations and alterations may occur depending on design requirements and other factors insofar as they are within the scope of the appended claims or the equivalents thereof.

### 4-1. Modification 1

For example, the foregoing embodiment describes an example in which the projection target in the present disclosure is the screen 20, but the configuration is not limited to such an example. The projection target may also be a solid body that acts as the target of projection by the display unit 124.

### 4-2. Modification 2

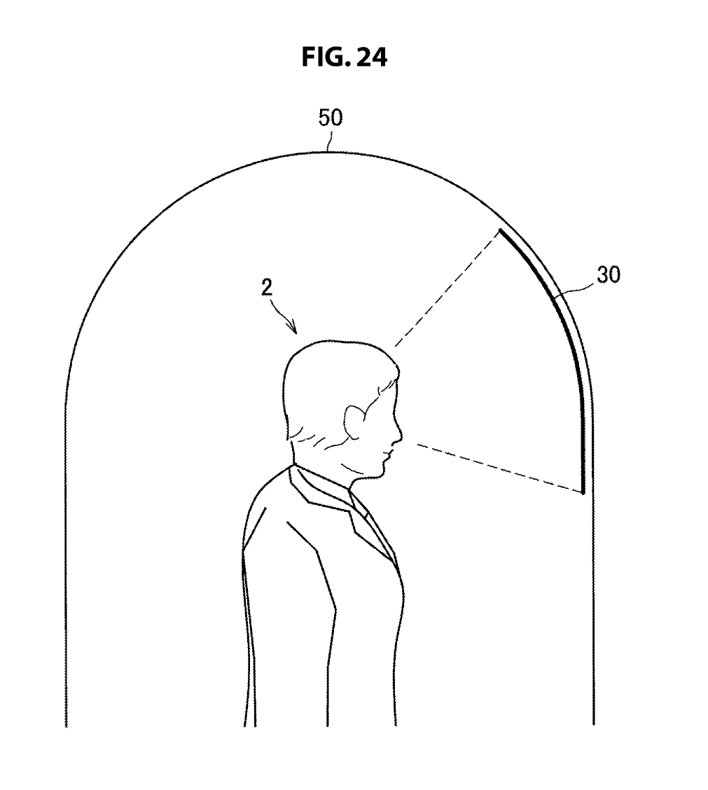

Also, the foregoing embodiment describes an example in which the display unit 124 projects an image onto the screen 20, but the configuration is not limited thereto. For example, as illustrated in FIG. 24, the display unit 124 may be a device enabling immersive display (such as the omnidirectional screen 50 illustrated in FIG. 24, or a head-mounted (for example, an eyewear-style or the like) display, for example), and in addition, the platform unit 100 or each application 200 may cause the display unit 124 to display display objects such as the window 30. In this case, as illustrated in FIG. 24, the window 30 may be displayed in full screen over the range of the field of view of the user 2. Additionally, the information processing system 10 may also set the image quality in consideration of the characteristics of human vision (such as the different characteristics in the central visual field and the peripheral visual field, for example).

Also, in the case in which the display unit 124 is a head-mounted (for example, an eyewear-style or the like) display, the display unit 124 may be a transmissive display or a non-transmissive display. In the latter case, a picture of the front of the display unit 124 may be projected by a camera attached to the display unit 124. In addition, the platform unit 100 or each application 200 may cause the display unit 124 to display display objects superimposed onto the image photographed by the camera.

### 4-3. Modification 3

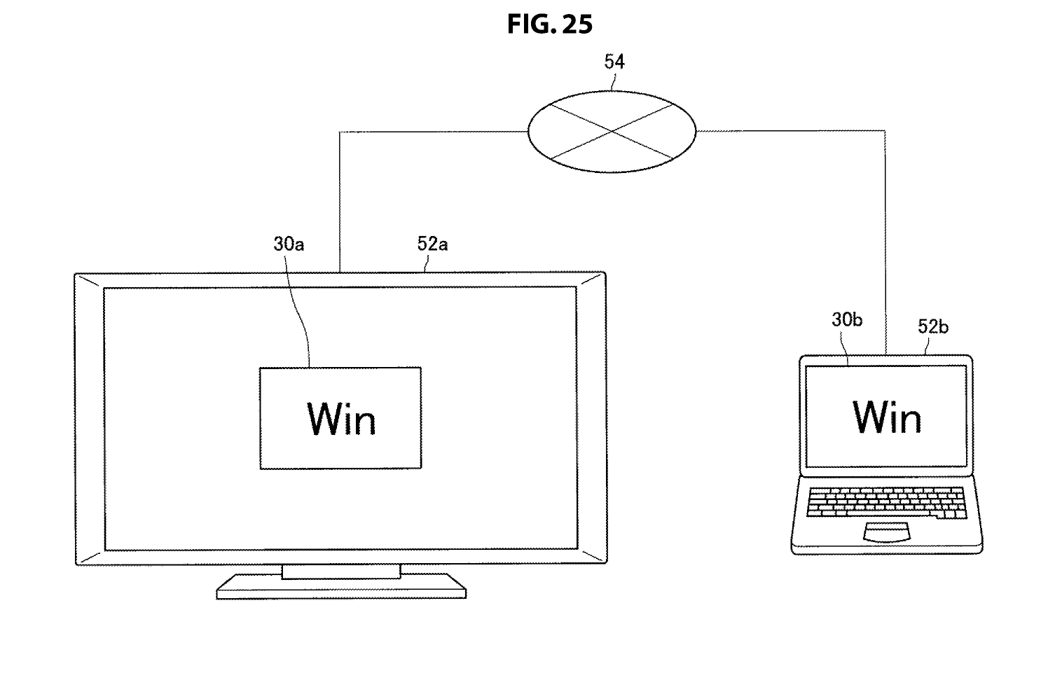

Also, as another modification, as illustrated in FIG. 25, the display unit 124 may also be the displays of terminals 52 placed in each of multiple locations. Note that in this case, the individual terminals 52 may be connected to each other via the communication network 54 to enable videoconferencing or the like, for example. Also, in a situation in which the same window 30 is being displayed on multiple terminals 52, and the window 30 is displayed in full screen, the size of the picture displayed on each of the multiple terminals 52 may be set to be approximately the same. In other words, the window 30 may be displayed on another terminal 52 at the size when displayed in full screen on the terminal 52 with the smallest screen size. With this arrangement, the same experience may be shared with another remote user.

### 4-4. Modification 4

Also, a device (information processing device) including the platform unit 100 according to the present embodiment may also include one or more of the communication unit 120, the sensor unit 122, and the display unit 124. For example, the information processing device may be a projector unit that includes the platform unit 100 and the display unit 124 (projection unit).

Alternatively, the information processing device may be configured in an integrated manner with the table 90. Alternatively, the information processing device may be a device connected via the communication network 54, for example, to at least one of the communication unit 120, the sensor unit 122, and the display unit 124. For example, the information processing device may be a server, a general-purpose personal computer (PC), a tablet-style terminal, a game console, a mobile phone such as a smartphone, a portable music player, a wearable device such as a head-mounted display (HMD), augmented reality (AR) glasses, or a smartwatch, for example, or a robot.

Also, the application 200 may be implemented inside the information processing device, or may be implemented inside a different device capable of communicating with the information processing device.

### 4-5. Modification 5

Further, the steps in the processing procedure described above are not necessarily to be executed in the described order. For example, the steps may be executed in the order changed as appropriate. In addition, the steps may be executed in parallel or individually in part, instead of being executed in chronological order. In addition, some of the steps described may be omitted, or an additional step may be added.

Further, according to the above-described embodiments, a computer program for causing hardware such as the CPU 150, the ROM 152, and the RAM 154 to execute the function equivalent to the function of each configuration of the information processing system 10 (in particular, the platform unit 100) according to the embodiment described above can be provided. in addition, a recording medium in which the computer program is recorded is provided.

Further, the effects described in this specification are merely illustrative or exemplified effects, and are not limitative. That is, with or in the place of the above effects, the technology according to the present disclosure may achieve other effects that are clear to those skilled in the art from the description of this specification.

Additionally, the present technology may also be configured as below.

(1) An information processing system including:

an acquisition unit configured to acquire direction information indicating a rotational angle of a display object displayed on a display screen, the rotational angle being with respect to a reference angle on the display screen, or a direction in which a user is positioned with respect to the display screen; and

a decision unit configured to decide, on a basis of the direction information, a direction of the display object with respect to the display screen when a display mode of the display object is switched to an enlarged display mode, in which

the rotational angle of the display object is different from a rotational angle of the display screen.

(2) The information processing system according to (1), in which

the display object is projected by a. projection unit onto a projection target that includes the display screen.

(3) The information processing system according to (2), in which

the display object is a window.

(4) The information processing system according to (2), in which

the display object is an operation object included in a window.

(5) The information processing system according to any one of (2) to (4), in which

at least two display objects are projected by the projection unit onto the projection target, and

the respective directions of the at least two display objects with respect to the projection target are different from each other.

(6) The information processing system according to any one of (2) to (5), in which

at least two display objects are projected by the projection unit onto the projection target, and

the decision unit decides the direction of the display object whose display mode is switched to the enlarged display mode among the at least two display objects, on a basis of the direction information of the display object switched to the enlarged display mode.

(7) The information processing system according to any one of (2) to (6), in which

the enlarged display mode is a full screen display mode.

(8) The information processing system according to any one of (2) to (7), in which

the direction information indicates a direction in which a user performing an operation on the display object is positioned.

(9) The information processing system according to any one of (2) to (7), in which

at least one user is positioned around the projection target, and

the direction information indicates a. direction in which most users are positioned with respect to the projection target.

(10) The information processing system according to any one of (2) to (9), in which

the decision unit additionally decides, on a basis of the direction information, a size of the display object when the display mode of the display object is switched to the enlarged display mode.

(11) The information processing system according to any one of (2) to (10), in which the acquisition unit additionally acquires information related to the projection target, and

the decision unit additionally decides, on a basis of the information related to the projection target, a size of the display object when the display mode of the display object is switched to the enlarged display mode.

(12) The information processing system according to (10) or (11), in which

the decision unit additionally decides, on a basis of a result of object recognition with respect to an image in which the projection target is imaged, the size of the display object when the display mode of the display object is switched to the enlarged display mode.

(13) The information processing system according to (12), further including:

a specification unit configured to specify, on the basis of the result of object recognition with respect to the image, a region other than a region of an object placed on the projection target, in which

the decision unit decides the size of the display object when the display mode of the display object is switched to the enlarged display mode to be a size corresponding to the region other than the region of the object placed on the projection target.

(14) The information processing system according to any one of (2) to (13), in which

display modes of the display object include a normal display mode and the enlarged display mode,

the information processing system further includes a storage unit configured to store a direction of the display object with respect to the projection target from immediately before the display mode of the display object is switched from the normal display mode to the enlarged display mode, and

when switching from the enlarged display mode to the normal display mode, the decision unit changes the direction of the display object with respect to the projection target to the direction of the display object with respect to the projection target from immediately before switching to the enlarged display mode stored in the storage unit.

(15) The information processing system according to (14), in which

the storage unit additionally stores a size of the display object from immediately before the display mode of the display object is switched from the normal display mode to the enlarged display mode, and

when switching from the enlarged display mode to the normal display mode, the decision unit additionally changes the size of the display object to the size of the display object from immediately before switching to the enlarged display mode stored in the storage unit,

(16) The information processing system according to any one of (2) to (15), in which

the enlarged display mode is a full screen display mode,

the display object is a window,

display modes of the window include a normal display mode, the full screen display mode, and a full window display mode,

when the display mode of the window is switched from the normal display mode to the full screen display mode, the decision unit changes a direction of the window with respect to the projection target on a basis of the direction information, and

when the display mode of the window is switched from the normal display mode to the full window display mode, the decision unit does not change the direction of the window with respect to the projection target.

(17) The information processing system according to any one of (2) to (16), further including:

a display control unit configured to cause the projection unit to project the display object onto the projection target, with the direction of the display object decided by the decision unit.

(18) The information processing system according to any one of (1) to 17), in which

the decision unit decides, on a basis of the direction information, the direction of the display object with respect to the display screen in the enlarged display mode to be a direction in units of 90 degrees.

(19) An information processing method including:

acquiring direction information indicating a rotational angle of a display object displayed on a display screen, the rotational angle being with respect to a reference angle on the display screen, or a direction in which a user is positioned with respect to the display screen; and

deciding, by a processor, on a basis of the direction information, a direction of the display object with respect to the display screen when a display mode of the display object is switched to an enlarged display mode, in which

the rotational angle of the display object is different from a rotational angle of the display screen.

(20) A program causing a computer to function as:

an acquisition unit configured to acquire direction information indicating a rotational angle of a display object displayed on a display screen, the rotational angle being with respect to a reference angle on the display screen, or a direction in which a user is positioned with respect to the display screen; and

a decision unit configured to decide, on a basis of the direction information, a direction of the display object with respect to the display screen when a display mode of the display object is switched to an enlarged display mode, in which

the rotational angle of the display object is different from a rotational angle of the display screen.

What is claimed is:

1. An information processing system comprising:
an acquisition unit configured to acquire direction information indicating a rotational angle of a display object displayed on a display screen, the rotational angle being with respect to a reference angle on the display screen, or a direction in which a user is positioned with respect to the display screen; and
a decision unit configured to decide, on a basis of the direction information, a direction of the display object with respect to the display screen when a display mode of the display object is switched to an enlarged display mode, wherein
the rotational angle of the display object is different from a rotational angle of the display screen.

2. The information processing system according to claim 1, wherein
the display object is projected by a projection unit onto a projection target that includes the display screen.

3. The information processing system according to claim 2, wherein
the display object is a window.

4. The information processing system according to claim 2, wherein
the display object is an operation object included in a window.

5. The information processing system according to claim 2, wherein
at least two display objects are projected by the projection unit onto the projection target, and
the respective directions of the at least two display objects with respect to the projection target are different from each other.

6. The information processing system according to claim 2, wherein
at least two display objects are projected by the projection unit onto the projection target, and
the decision unit decides the direction of the display object whose display mode is switched to the enlarged display mode among the at least two display objects, on a basis of the direction information of the display object switched to the enlarged display mode.

7. The information processing system according to claim 2, wherein
the enlarged display mode is a full screen display mode.

8. The information processing system according to claim 2, wherein
the direction information indicates a direction in which a user performing an operation on the display object is positioned.

9. The information processing system according to claim 2, wherein
at least one user is positioned around the projection target, and
the direction information indicates a direction in which most users are positioned with respect to the projection target.

10. The information processing system according to claim 2, wherein
the decision unit additionally decides, on a basis of the direction information, a size of the display object when the display mode of the display object is switched to the enlarged display mode.

11. The information processing system according to claim 2, wherein
the acquisition unit additionally acquires information related to the projection target, and
the decision unit additionally decides, on a basis of the information related to the projection target, a size of the display object when the display mode of the display object is switched to the enlarged display mode.

12. The information processing system according to claim 10, wherein
the decision unit additionally decides, on a basis of a result of object recognition with respect to an image in which the projection target is imaged, the size of the display object when the display mode of the display object is switched to the enlarged display mode.

13. The information processing system according to claim 12, further comprising:
a specification unit configured to specify, on the basis of the result of object recognition with respect to the image, a region other than a region of an object placed on the projection target, wherein
the decision unit decides the size of the display object when the display mode of the display object is switched to the enlarged display mode to be a size corresponding to the region other than the region of the object placed on the projection target.

14. The information processing system according to claim 2, wherein
display modes of the display object include a normal display mode and the enlarged display mode,
the information processing system further includes a storage unit configured to store a direction of the display object with respect to the projection target from immediately before the display mode of the display object is switched from the normal display mode to the enlarged display mode, and
when switching from the enlarged display mode to the normal display mode, the decision unit changes the direction of the display object with respect to the projection target to the direction of the display object with respect to the projection target from immediately before switching to the enlarged display mode stored in the storage unit.

15. The information processing system according to claim 14, wherein
the storage unit additionally stores a size of the display object from immediately before the display mode of the display object is switched from the normal display mode to the enlarged display mode, and
when switching from the enlarged display mode to the normal display mode, the decision unit additionally changes the size of the display object to the size of the display object from immediately before switching to the enlarged display mode stored in the storage unit.

16. The information processing system according to claim 2, wherein
the enlarged display mode is a full screen display mode,
the display object is a window,
display modes of the window include a normal display mode, the full screen display mode, and a full window display mode,
when the display mode of the window is switched from the normal display mode to the full screen display mode, the decision unit changes a direction of the window with respect to the projection target on a basis of the direction information, and
when the display mode of the window is switched from the normal display mode to the full window display mode, the decision unit does not change the direction of the window with respect to the projection target.

17. The information processing system according to claim 2, further comprising:
a display control unit configured to cause the projection unit to project the display object onto the projection target, with the direction of the display object decided by the decision unit.

18. The information processing system according to claim 1, wherein
the decision unit decides, on a basis of the direction information, the direction of the display object with respect to the display screen in the enlarged display mode to be a direction in units of 90 degrees.

19. An information processing method comprising:
acquiring direction information indicating a rotational angle of a display object displayed on a display screen, the rotational angle being with respect to a reference angle on the display screen, or a direction in which a user is positioned with respect to the display screen; and
deciding, by a processor, on a basis of the direction information, a direction of the display object with respect to the display screen when a display anode of the display object is switched to an enlarged display mode, wherein
the rotational angle of the display object is different from a rotational angle of the display screen.

20. A program causing a computer to function as:
an acquisition unit configured to acquire direction information indicating a rotational angle of a display object displayed on a display screen, the rotational angle being with respect to a reference angle on the display screen, or a direction in which a user is positioned with respect to the display screen; and
a decision unit configured to decide, on a basis of the direction information, a direction of the display object with respect to the display screen when a display mode of the display object is switched to an enlarged display mode, wherein
the rotational angle of the display object is different from a rotational angle of the display screen.
